(19) United States
(12) Patent Application Publication
(10) Pub. No.: US 2026/0235212 A1
(43) Pub. Date: Aug. 13, 2026

(54) ROTARY VALVE

(71) Applicant: AISIN CORPORATION, Kariya (JP)

(72) Inventor: Mitsutoshi KIKUCHI, Kariya-shi (JP)

(73) Assignee: AISIN CORPORATION, Kariya (JP)

(21) Appl. No.: 19/460,809

(22) Filed: Jan. 27, 2026

(30) Foreign Application Priority Data
Feb. 10, 2025 (JP) 2025-019896
Nov. 20, 2025 (JP) 2025-20083

(51) Int. Cl. F16K 11/052; B60N 2/90; F16K 31/524; A61H 9/00

(52) U.S. Cl. CPC F16K 11/052; B60N 2/976; F16K 31/52416; A61H 9/0078

(57) ABSTRACT

A rotary valve expanding and contracting air bags by switching an air-supply mode to the air bags, including: a lower case defining an air chamber supplied with air from a pump; an upper case above the lower case and having connecting flow paths connected to the air bags, and an opening surface where upstream ends of the connecting flow paths open; and a rotary in the upper case having an air-supply flow path connected to the air chamber, and that switches the connecting flow paths by rotating about a vertical axis in a state of contact with the opening surface of the upper case according to an increase and a decrease in pressure in the air chamber, where the upper case or the rotary has a locking portion locked to the other permitting rotation of the rotary about the vertical axis while restricting vertical movement of the rotary.

### CROSS REFERENCE TO RELATED APPLICATIONS

This application is based on and claims priority under 35 U.S.C. § 119 to Japanese Patent Application Nos. 2025-019896 and 2025-200863, filed on February 10, 2025, and November 20, 2025, respectively, the entire contents of which are incorporated herein by reference.

### TECHNICAL FIELD

The present disclosure relates to a rotary valve.

### BACKGROUND DISCUSSION

JP 2024-146479 A discloses a massage seat for massaging the body of a user seated. The massage seat includes a plurality of air bags incorporated in the seat cushion and the seat back, a rotary valve that switches between an air-supply state and an exhaust state for the plurality of air bags, and a pump that serves as an air-supply source for the plurality of air bags.

The rotary valve includes a lower case, an upper case, a rotary, a rotary spring, and a pressing portion. The lower case has an air chamber to which air is supplied from the pump. The upper case is stacked above the lower case. The lower case has a plurality of connecting flow paths whose downstream ends are connected to the plurality of air bags, respectively, and an opening surface at which upstream ends of the plurality of connecting flow paths open. The rotary is accommodated in the upper case. The rotary has an internal flow path connected to the air chamber. The rotary spring is accommodated in the upper case in a compressed state. The pressing portion is disposed inside the upper case and between the rotary and the rotary spring in the vertical direction. The pressing portion presses the rotary against the opening surface of the upper case by a restoring force of the rotary spring.

In the rotary valve, the rotary rotates about an axis extending in the vertical direction in a state of being in contact with the opening surface of the upper case according to an increase and a decrease in pressure in the air chamber. In this way, the rotary sequentially switches the connecting flow paths connected to the internal flow path, thereby sequentially switching the air bags connected to the air chamber. As a result, the plurality of air bags sequentially expand and contract.

A need thus exists for a rotary valve which is not susceptible to the drawback mentioned above.

### SUMMARY

A rotary valve that sequentially expands and contracts a plurality of air bags by switching an air-supply mode to the plurality of air bags, the rotary valve including: a lower case that defines an air chamber to which air is supplied from a pump; an upper case that has a plurality of connecting flow paths whose downstream ends are connected to the plurality of air bags, respectively, and an opening surface at which upstream ends of the plurality of connecting flow paths open, and that is stacked above the lower case; and a rotary that is accommodated in the upper case and has an air-supply flow path connected to the air chamber, and that sequentially switches the connecting flow paths connected to the air-supply flow path by rotating about an axis extending in a vertical direction in a state of being in contact with the opening surface of the upper case according to an increase and a decrease in pressure in the air chamber, in which one of the upper case and the rotary has a locking portion that is locked to the other of the upper case and the rotary and that allows rotation of the rotary about the axis extending in the vertical direction while restricting movement of the rotary in the vertical direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a seat including a rotary valve;

FIG. 2 is a perspective view of the rotary valve in FIG. 1;

FIG. 3 is an exploded perspective view of the rotary valve in FIG. 1;

FIG. 4 is an exploded perspective view of the rotary valve in FIG. 1;

FIG. 5 is a cross-sectional view of a cylinder of the rotary valve in FIG. 1;

FIG. 6 is a cross-sectional view of a lower guide of the rotary valve in FIG. 1;

FIG. 7 is a cross-sectional view of an upper guide of the rotary valve in FIG. 1;

FIG. 8 is a half cross-sectional view of a valve case of the rotary valve in FIG. 1;

FIG. 9 is a bottom view of the valve case of the rotary valve in FIG. 1;

FIG. 10 is a partially enlarged view of the valve case of the rotary valve in FIG. 1;

FIG. 11 is a plan view of a nozzle holder and an upper nozzle of the rotary valve in FIG. 1;

FIG. 12 is a cross-sectional view of a lower piston of the rotary valve in FIG. 1;

FIG. 13 is a cross-sectional view of a center piston of the rotary valve in FIG. 1;

FIG. 14 is an exploded perspective view of a rotary of the rotary valve in FIG. 1;

FIG. 15 is an exploded perspective view of the rotary in FIG. 14;

FIG. 16 is a plan view of the rotary in FIG. 14;

FIG. 17 is a cross-sectional view taken along line XVII-XVII of the rotary in FIG. 16;

FIG. 18 is a cross-sectional view taken along line XVIII-XVIII of the rotary in FIG. 16, and is a cross-sectional view for explaining a mounting configuration on the valve case in FIG. 9;

FIG. 19 is a cross-sectional view taken along line XVIII-XVIII of the rotary in FIG. 16, and is a cross-sectional view for explaining a mounting configuration on the valve case in FIG. 9;

FIG. 20 is a plan view of the rotary valve in FIG. 1;

FIG. 21 is a cross-sectional view taken along line A-A of the rotary valve in FIG. 20;

FIG. 22 is a cross-sectional view taken along line B-B of the rotary valve in FIG. 20;

FIG. 23 is a schematic view illustrating a position of a boss base of the rotary valve in FIG. 22;

FIG. 24 is a cross-sectional view taken along line XXIV-XXIV of the rotary valve in FIG. 22;

FIG. 25 is a cross-sectional view taken along line B-B when the lower piston rises in the rotary valve in FIG. 20;

FIG. 26 is a cross-sectional view taken along line B-B when the lower piston and the center piston rise in the rotary valve in FIG. 20;

FIG. 27 is a schematic view illustrating movement of the boss base of the rotary valve in FIG. 26;

FIG. 28 is a cross-sectional view taken along line XXVIII-XXVIII of the rotary valve in FIG. 26;

FIG. 29 is a cross-sectional view taken along line B-B when the lower piston and the center piston descend in the rotary valve in FIG. 20;

FIG. 30 is a schematic view illustrating movement of the boss base of the rotary valve in FIG. 29;

FIG. 31 is a cross-sectional view taken along line XXXI-XXXI of the rotary valve in FIG. 29;

FIG. 32 is a cross-sectional view taken along line C-C when the lower piston and the center piston descend in the rotary valve in FIG. 20;

FIG. 33 is a cross-sectional view taken along line A-A when drive of a pump is stopped in the rotary valve in FIG. 20; and

FIG. 34 is a cross-sectional view taken along line A-A when the drive of the pump is stopped in the rotary valve in FIG. 20.

### DETAILED DESCRIPTION

Hereinafter, a seat including a rotary valve will be described with reference to the drawings. In order to clarify cross-sectional illustrations, the line type of hatching used in sectional views is a line type for metal regardless of the materials of the members.

### Configuration of Present Embodiment

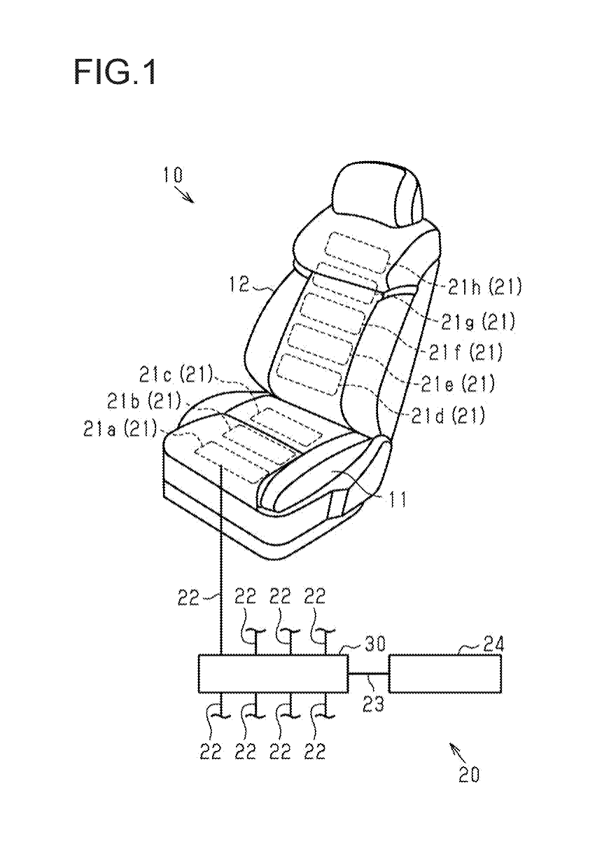

As illustrated in FIG. 1, a seat 10 includes a seat cushion 11, a seat back 12, and a pneumatic system 20. The seat 10 is, for example, a vehicle seat such as a driver’s seat, a front passenger seat, or a rear seat of a vehicle. In other embodiments, the seat 10 may be a massage seat for use in facilities, homes, and the like.

### Pneumatic System 20

The pneumatic system 20 includes eight air bags 21 (21a to 21h), eight connecting tubes 22, a supply tube 23, a pump 24, and a rotary valve 30. The pneumatic system 20 is preferably incorporated in the seat 10.

The eight air bags 21 are incorporated in the seat cushion 11 and the seat back 12. Specifically, three air bags 21a to 21c are incorporated in the seat cushion 11. Five air bags 21d to 21h are incorporated in the seat back 12. The three air bags 21a to 21c are configured to massage the buttocks and the legs of a user seated on the seat 10. On the other hand, the five air bags 21d to 21h are configured to massage the back of a user seated on the seat 10. The air bag 21 expands when air is supplied thereto and contracts when air is discharged therefrom. For example, the air bag 21 may be formed by welding outer edges of two resin films to each other. In other embodiments, the number of the air bags 21 can be changed as appropriate.

The eight connecting tubes 22 connect the eight air bags 21 and the rotary valve 30. The supply tube 23 connects the pump 24 and the rotary valve 30. The connecting tube 22 and the supply tube 23 preferably have appropriate elasticity so as to be easily routed within the seat 10. In other embodiments, the connecting tube 22 and the supply tube 23 may be resin tubes or steel tubes.

The pump 24 may be any pump capable of delivering air. The pump 24 is driven by power supplied from a battery (not illustrated). In the following description, upstream and downstream are defined following a flow of air delivered by the pump 24. In this respect, the pump 24 is located most upstream in the pneumatic system 20.

### Rotary Valve 30

The rotary valve 30 is a device that sequentially expands and contracts the eight air bags 21 by switching an air-supply mode to the eight air bags 21.

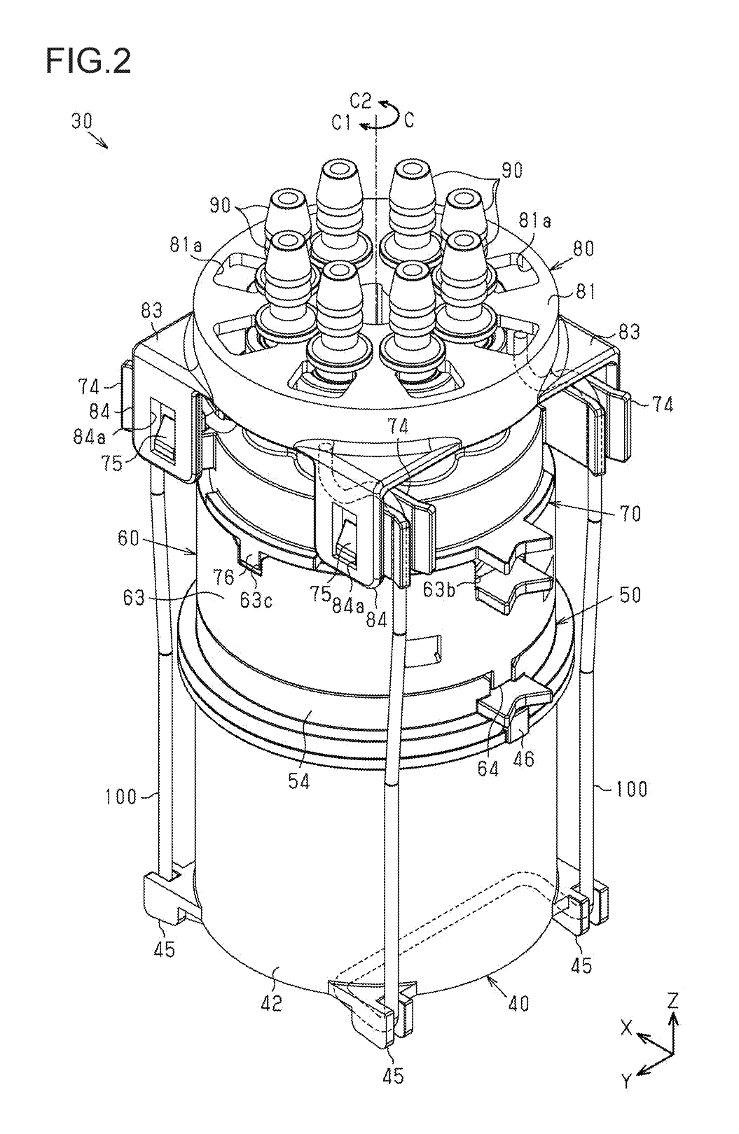

As illustrated in FIG. 2, the rotary valve 30 has a cylindrical shape. In the following description, an axial direction of the rotary valve 30 is defined as a vertical direction Z, a direction orthogonal to the vertical direction Z is defined as a first direction X, and a direction orthogonal to both the vertical direction Z and the first direction X is defined as a second direction Y. The radial direction of the rotary valve 30 is simply referred to as a radial direction, and a circumferential direction C of the rotary valve 30 is simply referred to as a circumferential direction C. Furthermore, the circumferential direction C includes a first circumferential direction C1 and a second circumferential direction C2 that is a direction opposite to the first circumferential direction C1. The rotary valve 30 includes many components having the same axial direction, radial direction, and circumferential direction C as those of the rotary valve 30. Therefore, in the description of these components, the axial directions, the radial directions, and the circumferential directions C of these components are simply referred to as an axial direction, a radial direction, and a circumferential direction C.

The vertical direction Z of the rotary valve 30 is independent of the vertical direction Z of the seat 10 on which the rotary valve 30 is to be mounted. For example, in a situation where the rotary valve 30 is mounted on the seat 10, the vertical direction Z of the rotary valve 30 may be the front-rear direction of the seat 10 or the width direction of the seat 10.

As illustrated in FIGS. 2 to 4, the rotary valve 30 includes a cylinder 40, a lower guide 50, an upper guide 60, a valve case 70, a nozzle holder 80, eight upper nozzles 90, and two clamps 100. The rotary valve 30 also includes a lower piston 110, a center piston 120, a boss base 130, a stopper ring 140, a rotary 160, a lower spring SP1, and a center spring SP2. In the present embodiment, the cylinder 40 corresponds to a “lower case”. The lower guide 50, the upper guide 60, and the valve case 70 constitute an “upper case”.

### Cylinder 40

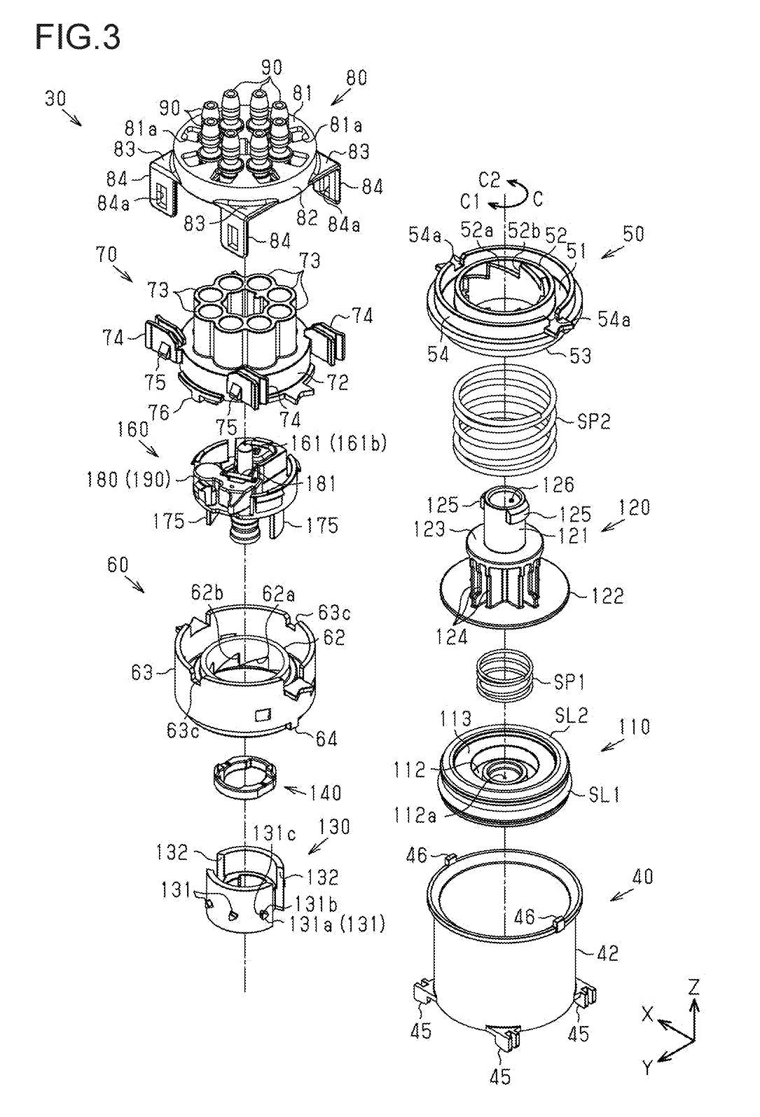

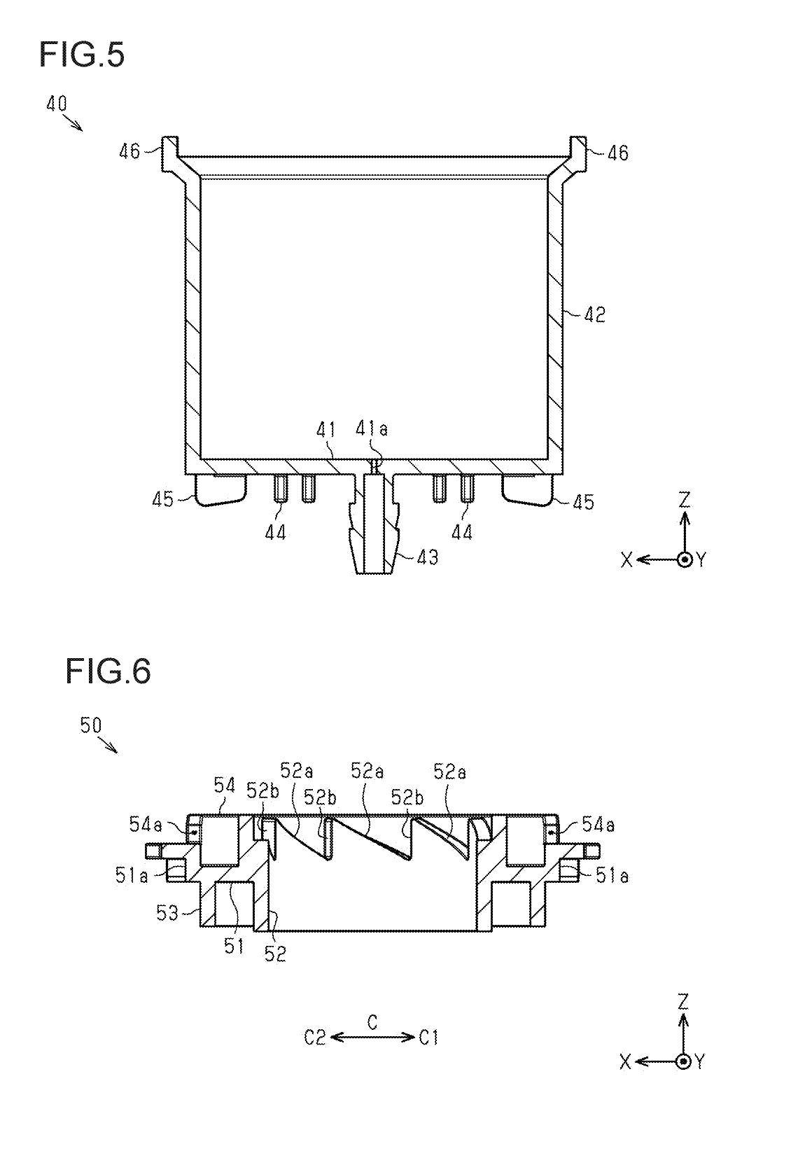

As illustrated in FIGS. 3 to 5, the cylinder 40 includes a bottom wall 41, a peripheral wall 42, a lower nozzle 43, four lower clamp holders 44, four lower clamp guides 45, and two positioning projections 46. The cylinder 40 is, for example, a resin molded product.

The bottom wall 41 has a disk shape. The axial direction of the bottom wall 41 is the vertical direction Z. The bottom wall 41 has a communication hole 41a. The peripheral wall 42 has a cylindrical shape. The axial direction of the peripheral wall 42 is the vertical direction Z. The peripheral wall 42 extends upward from the outer edge of the bottom wall 41. The lower nozzle 43 is located at the central portion of the bottom wall 41 and extends downward from the lower surface of the bottom wall 41. The lower nozzle 43 is connected to the inside of the cylinder 40 through the communication hole 41a. The lower nozzle 43 is a portion to which the downstream end of the supply tube 23 is connected.

The four lower clamp holders 44 are provided on the lower surface of the bottom wall 41. Two of the four lower clamp holders 44 are arranged in the first direction X, and the other two are arranged in the second direction Y. The lower clamp holders 44 are configured to hold the clamps 100. The four lower clamp guides 45 protrude from the bottom wall 41 along the first direction X. When the cylinder 40 is viewed from the bottom surface, two of the four lower clamp guides 45 are arranged in the first direction X, and the other two are arranged in the second direction Y. The lower clamp guides 45 are configured to hold the clamps 100 together with the lower clamp holders 44. The two positioning projections 46 protrude upward from the upper end of the peripheral wall 42. The two positioning projections 46 are arranged at equal intervals in the circumferential direction C.

### Lower Guide 50

As illustrated in FIGS. 3, 4, and FIG. 6, the lower guide 50 includes an intermediate wall 51, an inner peripheral wall 52, a lower outer peripheral wall 53, and an upper outer peripheral wall 54. The lower guide 50 is, for example, a resin molded product.

The intermediate wall 51 has a disk shape with a hole at the central portion. The plate thickness direction of the intermediate wall 51 is the vertical direction Z. The intermediate wall 51 has two positioning recesses 51a. The two positioning recesses 51a are recessed from the outer surface in the radial direction toward the axis of the intermediate wall 51. The two positioning recesses 51a are arranged at equal intervals in the circumferential direction C.

The inner peripheral wall 52 has a cylindrical shape. The axial direction of the inner peripheral wall 52 is the vertical direction Z. The inner peripheral wall 52 extends upward and downward from the inner edge of the intermediate wall 51. The inner peripheral wall 52 has a plurality of lower sliding surfaces 52a and a plurality of lower restricting surfaces 52b. The number of the lower sliding surfaces 52a formed and the number of the lower restricting surfaces 52b formed are both “eight”, each of which is equal to the number of the air bags 21. The eight lower sliding surfaces 52a and the eight lower restricting surfaces 52b are alternately arranged in the circumferential direction C. The lower sliding surface 52a is inclined downward as it advances in the first circumferential direction C1. That is, the lower restricting surfaces 52b intersect both the vertical direction Z and the circumferential direction C. The lower restricting surfaces 52b extend in the vertical direction Z. That is, the lower restricting surfaces 52b are surfaces orthogonal to the circumferential direction C. In the present embodiment, the lower restricting surface 52b connects the front end in the first circumferential direction C1 of the lower sliding surface 52a and the rear end in the first circumferential direction C1 of the lower sliding surface 52a, which are adjacent to each other in the circumferential direction C.

The lower outer peripheral wall 53 and the upper outer peripheral wall 54 have cylindrical shapes. The axial direction of the lower outer peripheral wall 53 and the axial direction of the upper outer peripheral wall 54 are the vertical direction Z. The lower outer peripheral wall 53 extends downward from the intermediate wall 51, and the upper outer peripheral wall 54 extends upward from the intermediate wall 51. The inner diameter of the lower outer peripheral wall 53 and the inner diameter of the upper outer peripheral wall 54 are larger than the outer diameter of the inner peripheral wall 52. In this respect, in the radial direction, a space exists between the lower outer peripheral wall 53 and the inner peripheral wall 52, and a space exists between the upper outer peripheral wall 54 and the inner peripheral wall 52. The upper outer peripheral wall 54 has two positioning recesses 54a. The two positioning recesses 54a are recessed downward from the upper surface of the upper outer peripheral wall 54. The two positioning recesses 54a are arranged at equal intervals in the circumferential direction C. In the lower guide 50, the formation positions of the two positioning recesses 51a and the formation positions of the two positioning recesses 54a are aligned in the vertical direction Z.

### Upper Guide 60

As illustrated in FIGS. 3, 4, and 7, the upper guide 60 includes an intermediate wall 61, an inner peripheral wall 62, an outer peripheral wall 63, and two positioning projections 64. The upper guide 60 is, for example, a resin molded product.

The intermediate wall 61 has a disk shape with a hole at the central portion. The plate thickness direction of the intermediate wall 61 is the vertical direction Z. The inner peripheral wall 62 has a cylindrical shape. The axial direction of the inner peripheral wall 62 is the vertical direction Z. The inner peripheral wall 62 extends upward and downward from the inner edge of the intermediate wall 61. The inner diameter of the inner peripheral wall 62 is equal to the inner diameter of the inner peripheral wall 52 of the lower guide 50.

The inner peripheral wall 62 has a plurality of upper sliding surfaces 62a and a plurality of upper restricting surfaces 62b. The number of the upper sliding surfaces 62a formed and the number of the upper restricting surfaces 62b formed are both “eight”, each of which is equal to the number of the air bags 21. The eight upper sliding surfaces 62a and the eight upper restricting surfaces 62b are alternately arranged in the circumferential direction C. The upper sliding surface 62a is inclined upward as it advances in the first circumferential direction C1. That is, the upper restricting surface 62b intersects both the vertical direction Z and the circumferential direction C. In the circumferential direction C, the length of the upper sliding surface 62a is equal to the length of the lower sliding surface 52a. The upper restricting surface 62b extends in the vertical direction Z. That is, the upper restricting surface 62b is a surface orthogonal to the circumferential direction C. The upper restricting surface 62b connects the front end in the first circumferential direction C1 of the upper sliding surface 62a and the rear end in the first circumferential direction C1 of the upper sliding surface 62a.

The outer peripheral wall 63 has a cylindrical shape. The axial direction of the outer peripheral wall 63 is the vertical direction Z. The outer peripheral wall 63 extends upward and downward from the outer edge of the intermediate wall 61. The inner diameter of the outer peripheral wall 63 is larger than the outer diameter of the inner peripheral wall 62. The outer peripheral wall 63 has two positioning recesses 63c. The two positioning recesses 63c are recessed downward from the upper end of the intermediate wall 61. The two positioning recesses 63c are arranged at equal intervals in the circumferential direction C. The two positioning projections 64 protrude downward from the lower end of the outer peripheral wall 63. The two positioning projections 64 are arranged at equal intervals in the circumferential direction C.

### Valve Case 70

As illustrated in FIGS. 3, 4, and 8 to 10, the valve case 70 includes an upper wall 71, a sliding wall 72, eight cylindrical walls 73, four upper clamp holders 74, four locking protrusions 75, and two positioning projections 76. The valve case 70 is, for example, a resin molded product.

The upper wall 71 has a disk shape. The axial direction of the upper wall 71 is the vertical direction Z. The upper wall 71 has a shaft hole 71a and eight connecting flow paths 77 (77a to 77h). The shaft hole 71a and the eight connecting flow paths 77 penetrate the upper wall 71 in the plate thickness direction. The shaft hole 71a and the eight connecting flow paths 77 have circular shapes in plan view in the vertical direction Z. The shaft hole 71a is located at the central portion of the upper wall 71. When the upper wall 71 is viewed from the vertical direction Z, the eight connecting flow paths 77 are arranged at equal intervals in the circumferential direction C. The distances from the axis of the valve case 70 to the formation positions of the eight connecting flow paths 77 on the upper wall 71 are equal to each other. Lower ends of the eight connecting flow paths 77, that is, upstream ends of the eight connecting flow paths 77 open at the lower surface of the upper wall 71. On the other hand, the upper ends of the eight connecting flow paths 77, that is, the downstream ends of the eight connecting flow paths 77 open at the upper surface of the upper wall 71. In the following description, the lower surface of the upper wall 71 of the valve case 70 is referred to as an “opening surface 71b”.

As illustrated in FIGS. 8 to 10, the sliding wall 72 has a peripheral wall 721 and eight sliding projections 722. The sliding wall 72 has an accommodating groove 723. The peripheral wall 721 has a cylindrical shape. The axial direction of the peripheral wall 721 is the vertical direction Z. The peripheral wall 721 extends downward from the outer edge of the upper wall 71. In this respect, the sliding wall 72 extends downward from the outer edge of the upper wall 71. The eight sliding projections 722 protrude from the inner peripheral surface of the peripheral wall 721 toward the axis of the peripheral wall 721. The eight sliding projections 722 are arranged at equal intervals in the radial direction. The eight sliding projections 722 have a rectangular plate shape. The plate thickness direction of the eight sliding projections 722 is the radial direction.

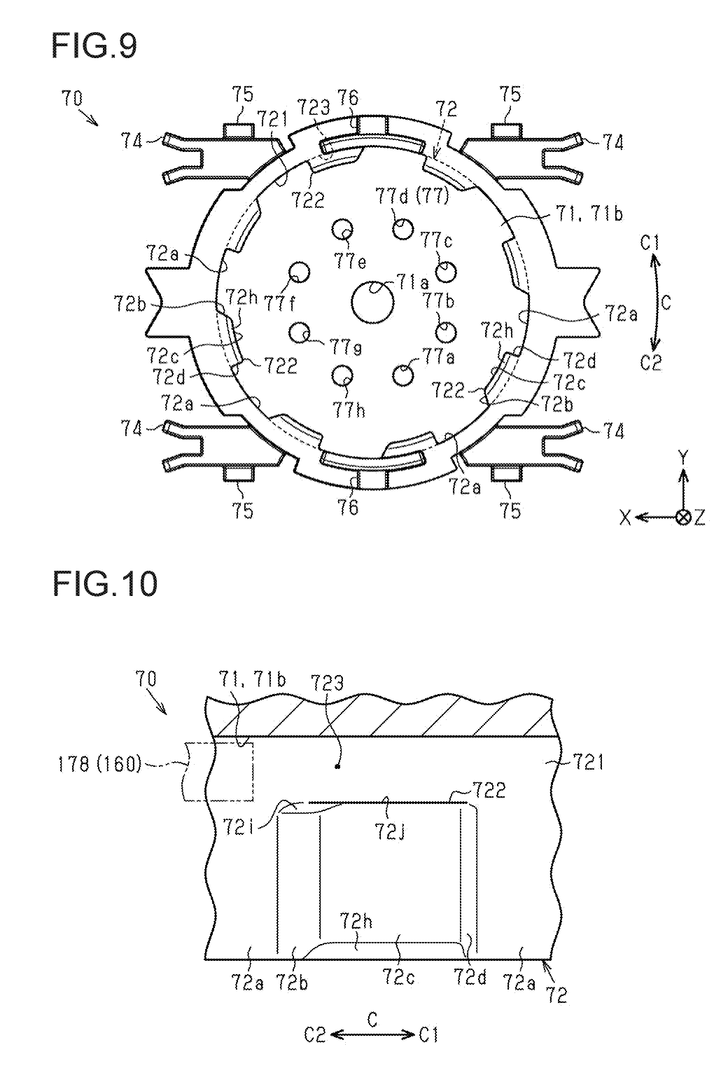

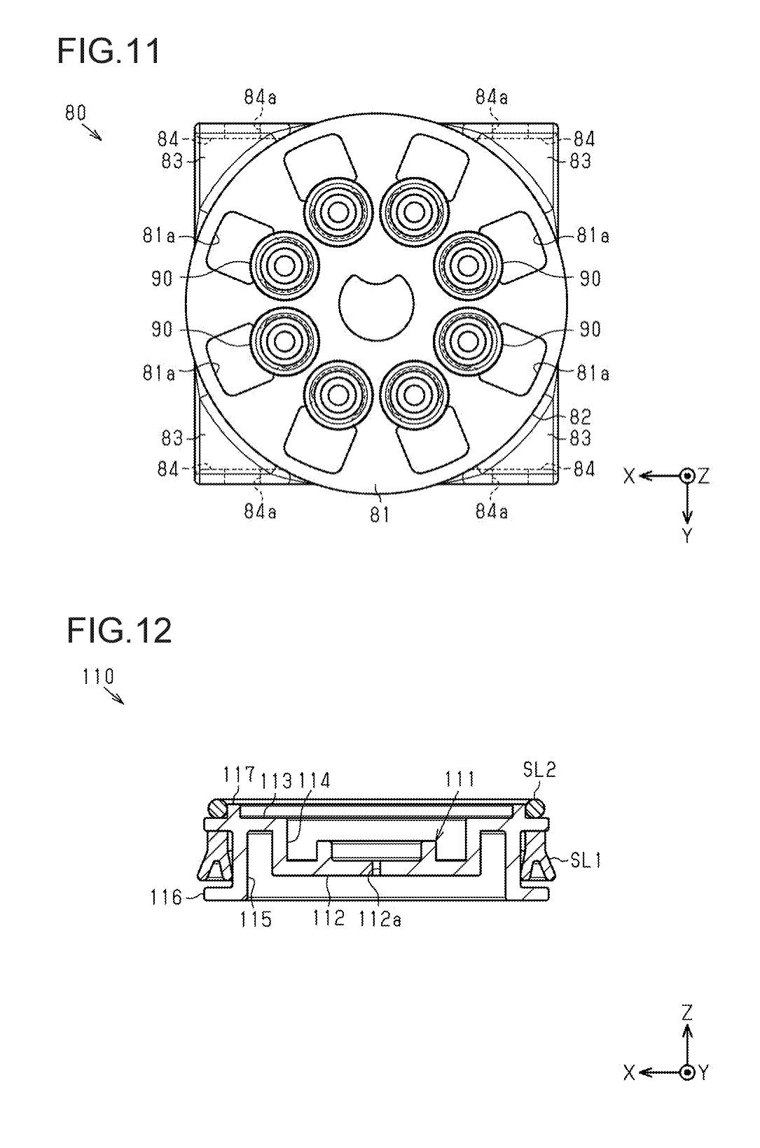

As illustrated in FIGS. 9 and 10, the sliding wall 72 has eight first sliding surfaces 72a, eight second sliding surfaces 72b, eight third sliding surfaces 72c, eight connecting surfaces 72d, eight insertion guide surfaces 72h, eight rotation guide surfaces 72i, and eight holding surfaces 72j. In other words, the peripheral wall 721 has eight first sliding surfaces 72a. The sliding projection 722 has a second sliding surface 72b, a third sliding surface 72c, a connecting surface 72d, an insertion guide surface 72h, a rotation guide surface 72i, and a holding surface 72j.

The first sliding surface 72a and the third sliding surface 72c are surfaces along an arc centered on the axis of the sliding wall 72. The radius of the arc constituting the first sliding surface 72a is larger than the radius of the arc constituting the third sliding surface 72c. In other words, the distance from the axis of the valve case 70 to the first sliding surface 72a is longer than the distance from the axis of the valve case 70 to the third sliding surface 72c. The second sliding surface 72b intersects both the radial direction and the circumferential direction C. The second sliding surface 72b is directed radially inward as it advances in the first circumferential direction C1. The second sliding surface 72b connects the first sliding surface 72a and the third sliding surface 72c, which are offset from each other in the radial direction. The connecting surface 72d is a surface extending in the radial direction. The connecting surface 72d connects the first sliding surface 72a and the third sliding surface 72c, which are offset from each other in the radial direction. In this way, the first sliding surface 72a, the second sliding surface 72b, the third sliding surface 72c, and the connecting surface 72d are arranged in order in the first circumferential direction C1. In this respect, it can be said that the distance from the sliding wall 72 of the valve case 70 to the rotational axis of the rotary 160 changes in the rotational direction of the rotary 160.

FIG. 10 is a schematic view of one of the eight sliding projections 722 as viewed from the axis of the peripheral wall 721.

As illustrated in FIG. 10, the insertion guide surface 72h is provided at the tip of the sliding wall 72. The insertion guide surface 72h constitutes the lower surface of the sliding projection 722. The insertion guide surface 72h is inclined upward as it advances toward the axis of the peripheral wall 721 in the radial direction. In other words, the insertion guide surface 72h is inclined to approach the opening surface 71b of the upper wall 71 as it advances toward the axis of the peripheral wall 721 in the radial direction. The insertion guide surface 72h connects the second sliding surface 72b and the connecting surface 72d in the circumferential direction C.

The rotation guide surface 72i and the holding surface 72j constitute the upper surface of the sliding projection 722. The rotation guide surface 72i is inclined upward as it advances in the first circumferential direction C1. In other words, the rotation guide surface 72i is inclined to approach the opening surface 71b of the upper wall 71 as it advances in the first circumferential direction C1. On the other hand, the holding surface 72j is a surface parallel to the opening surface 71b of the upper wall 71. In this respect, the interval between the holding surface 72j and the opening surface 71b of the upper wall 71 in the vertical direction Z is constant in the circumferential direction C. The holding surface 72j is connected to the rotation guide surface 72i. The holding surface 72j is located at a position advanced in the first circumferential direction C1 from the rotation guide surface 72i.

The accommodating groove 723 is a gap between the eight sliding projections 722 and the opening surface 71b of the upper wall 71 in the vertical direction Z. That is, the accommodating groove 723 is provided at the base end of the sliding wall 72. In the present embodiment, the accommodating groove 723 has an annular shape. To be precise, the accommodating groove 723 is divided in the circumferential direction C in that the eight sliding projections 722 are arranged at equal intervals in the circumferential direction C. In this respect, the annular accommodating groove 723 is intended to include the accommodating grooves 723 that are divided in the circumferential direction C.

As illustrated in FIGS. 3, 4, and 8, the cylindrical wall 73 has a cylindrical shape. The axial direction of the cylindrical wall 73 is the vertical direction Z. The cylindrical wall 73 extends upward from the upper wall 71. In plan view in the vertical direction Z, the eight cylindrical walls 73 are arranged at equal intervals in the circumferential direction C. In the present embodiment, the two cylindrical walls 73 adjacent to each other in the circumferential direction C are integrally formed, but in other embodiments, the two cylindrical walls 73 adjacent to each other in the circumferential direction C may be formed as separate bodies. In the internal spaces of the eight cylindrical walls 73, the upper ends of the eight connecting flow paths 77, that is, the downstream ends of the eight connecting flow paths 77 open, respectively. That is, one connecting flow path 77 is connected to the internal space of one cylindrical wall 73.

The four upper clamp holders 74 protrude from the sliding wall 72 in the first direction X. Two of the four upper clamp holders 74 are arranged in the first direction X, and the other two are arranged in the second direction Y. The upper clamp holder 74 is configured to hold the clamp 100. The four locking protrusions 75 protrude from the four upper clamp holders 74, respectively. The protruding direction of the locking protrusion 75 from the upper clamp holder 74 is the second direction Y. The length of the locking protrusion 75 in the protruding direction increases as it advances downward. The two positioning projections 76 protrude downward from the lower end of the cylindrical wall 73. The two positioning projections 76 are arranged at equal intervals in the circumferential direction C.

### Nozzle Holder 80

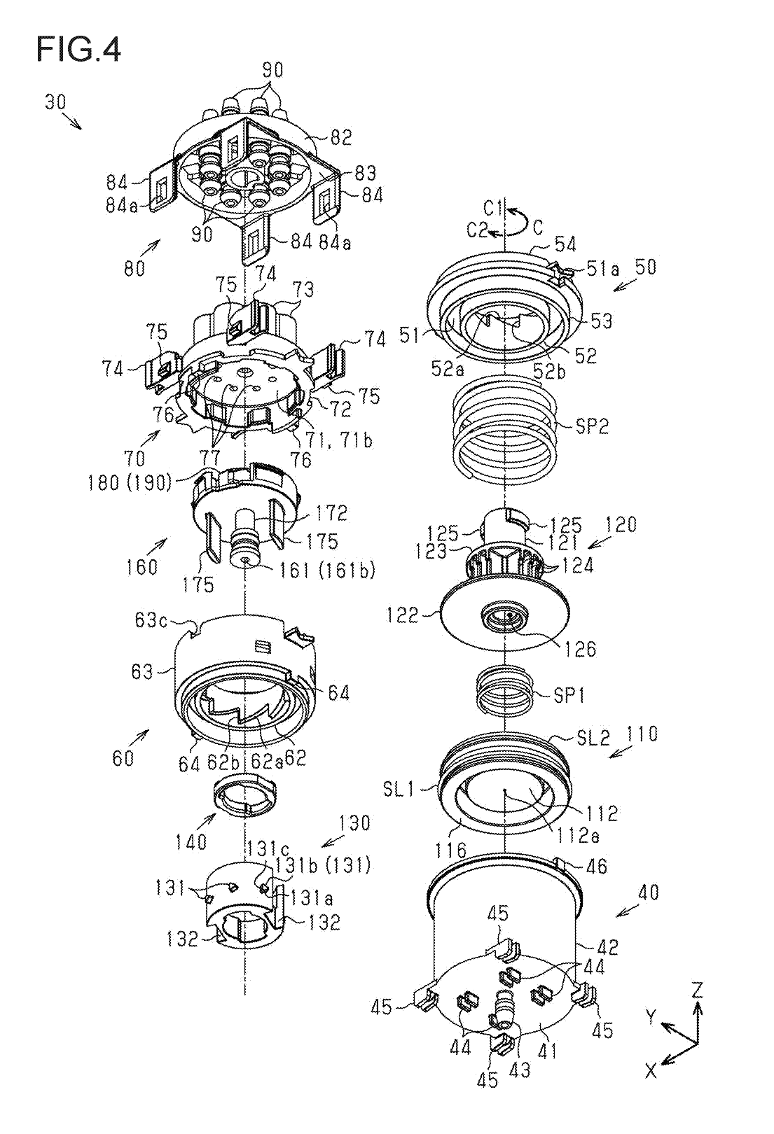

As illustrated in FIGS. 3, 4., and 11, the nozzle holder 80 has a holding wall 81, a peripheral wall 82, four connecting walls 83, and four locking walls 84. The nozzle holder 80 is, for example, a resin molded product.

The holding wall 81 has a disk shape. The plate thickness direction of the holding wall 81 is the vertical direction Z. The holding wall 81 has eight support holes 81a. The eight support holes 81a penetrate the holding wall 81 in the plate thickness direction. The eight support holes 81a are arranged at equal intervals in the circumferential direction C. The holding wall 81 supports the eight upper nozzles 90 through the eight support holes 81a. In a state where the holding wall 81 supports the upper nozzles 90, the upper nozzles 90 cannot move in the plate thickness direction with respect to the holding wall 81. The peripheral wall 82 has a cylindrical shape. The axial direction of the peripheral wall 82 is the vertical direction Z. The peripheral wall 82 extends downward from the outer edge of the holding wall 81.

The four connecting walls 83 have a plate shape. The plate thickness direction of the four connecting walls 83 is the vertical direction Z. As viewed from the vertical direction Z, the connecting wall 83 has a triangular shape. The four connecting walls 83 extend from the lower end of the peripheral wall 82 in the second direction Y. The four locking walls 84 have a plate shape. The plate thickness direction of the four locking walls 84 is the second direction Y. The four locking walls 84 extend downward from the four connecting walls 83, respectively. The locking wall 84 has a locking hole 84a. The locking hole 84a penetrates the locking wall 84 in the plate thickness direction. The locking hole 84a has a shape corresponding to the locking protrusion 75 of the valve case 70. In the present embodiment, the locking hole 84a has a rectangular shape as viewed from the second direction Y.

### Clamp 100

As illustrated in FIG. 2, the clamp 100 has an elongated rod shape. The clamp 100 is formed, for example, by bending an elastically deformable metal wire. The elastic modulus of the clamp 100 is preferably such an elastic modulus that an assembly worker for the rotary valve 30 can elastically deform the clamp 100. Here, the assembly worker may be a person or a robot.

### Lower Piston 110

As illustrated in FIGS. 3, 4, and 12, the lower piston 110 includes a main body portion 111, a first seal SL1, and a second seal SL2. The main body portion 111 is formed of, for example, a resin material, and the first seal SL1 and the second seal SL2 are formed of, for example, an elastomer such as rubber.

The main body portion 111 has a bottom wall 112, an upper wall 113, an inner peripheral wall 114, an outer peripheral wall 115, a first support wall 116, and a second support wall 117.

The bottom wall 112 has a disk shape. The axial direction of the bottom wall 112 is the vertical direction Z. The bottom wall 112 has a communication flow path 112a. The communication flow path 112a penetrates the central portion of the bottom wall 112 in the plate thickness direction. The inner diameter of the communication flow path 112a is larger than the inner diameter of the communication hole 41a of the cylinder 40. That is, the flow path cross-sectional area of the communication flow path 112a is larger than the flow path cross-sectional area of the communication hole 41a of the cylinder 40. The formation position of the communication flow path 112a and the number of the communication flow paths 112a formed can be appropriately changed. The upper wall 113 has a disk shape with a hole at the central portion. The axial direction of the upper wall 113 is the vertical direction Z. The upper wall 113 is positioned above the bottom wall 112.

The inner peripheral wall 114 and the outer peripheral wall 115 have cylindrical shapes. The axial direction of the inner peripheral wall 114 and the axial direction of the outer peripheral wall 115 are the vertical direction Z. The inner peripheral wall 114 connects the outer edge of the bottom wall 112 and the inner edge of the upper wall 113 in the vertical direction Z. The inner diameter of the outer peripheral wall 115 is larger than the outer diameter of the inner peripheral wall 114. The outer peripheral wall 115 extends downward from the upper wall 113. In the radial direction, a gap exists between the outer peripheral wall 115 and the inner peripheral wall 114. The first support wall 116 has a flange shape. The plate thickness direction of the first support wall 116 is the vertical direction Z. The first support wall 116 extends radially outward from the lower end of the outer peripheral wall 115. The second support wall 117 has an annular shape. The axial direction of the second support wall 117 is the vertical direction Z. The second support wall 117 protrudes upward from the upper wall 113.

The first seal SL1 has an annular shape. The first seal SL1 is supported by the upper wall 113, the outer peripheral wall 115, and the first support wall 116. Specifically, the first seal SL1 is disposed in an area defined by the lower surface of the upper wall 113, the outer surface of the outer peripheral wall 115, and the upper surface of the first support wall 116. The first seal SL1 is a member located on the radially outermost side in the lower piston 110. The second seal SL2 has an annular shape. The second seal SL2 is supported by the upper wall 113 and the second support wall 117 of the main body portion 111. At this time, the second seal SL2 is in contact with the upper surface of the upper wall 113 and the outer surface of the second support wall 117. The second seal SL2 is a member located at the uppermost position in the lower piston 110.

### Center Piston 120

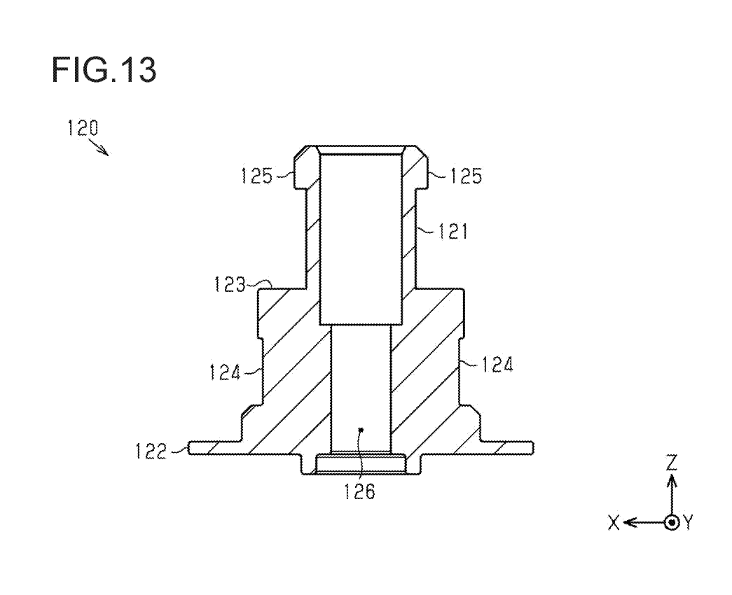

As illustrated in FIGS. 3, 4, and 13, the center piston 120 includes a shaft portion 121, a sliding flange 122, a support flange 123, a plurality of reinforcing ribs 124, and two protruding portions 125. The center piston 120 also has an internal flow path 126. The center piston 120 is, for example, a resin molded product.

The shaft portion 121 has a cylindrical shape. An internal space penetrating the shaft portion 121 in the vertical direction Z is the internal flow path 126. The flow path cross-sectional area of the internal flow path 126 is larger than the flow path cross-sectional area of the communication flow path 112a of the lower piston 110. The axial direction of the shaft portion 121 is the vertical direction Z. The sliding flange 122 and the support flange 123 have disk shapes. The plate thickness direction of the sliding flange 122 and the support flange 123 is the vertical direction Z. The sliding flange 122 extends radially outward from the lower end of the shaft portion 121. The outer diameter of the sliding flange 122 is slightly smaller than the inner diameter of the cylinder 40. The support flange 123 extends radially outward from an intermediate portion of the shaft portion 121 in the vertical direction Z. The outer diameter of the support flange 123 is smaller than the outer diameter of the sliding flange 122.

The plurality of reinforcing ribs 124 have a plate shape. The thickness direction of the plurality of reinforcing ribs 124 is a direction orthogonal to the vertical direction Z. The plurality of reinforcing ribs 124 connect the sliding flange 122 and the support flange 123 in the vertical direction Z. The two protruding portions 125 protrude radially outward from the tip of the shaft portion 121. The two protruding portions 125 are arranged at equal intervals in the radial direction.

### Boss Base 130 and Stopper Ring 140

As illustrated in FIGS. 3 and 4, the boss base 130 has a cylindrical shape. The axial direction of the boss base 130 is the vertical direction Z. The boss base 130 has six bosses 131. The boss base 130 also has two engaging recesses 132. The boss base 130 is, for example, a resin molded product.

The six bosses 131 protrude radially outward from the outer peripheral surface of the boss base 130. The six bosses 131 are arranged in the circumferential direction C. The formation positions in the vertical direction Z of the six bosses 131 are equal to each other. When one boss 131 is viewed from the front in the protruding direction, the boss 131 has a triangular shape.

The boss 131 has a lower cam surface 131a, an upper cam surface 131b, and a contact surface 131c as surfaces orthogonal to the protruding direction. The lower cam surface 131a is inclined downward as it advances in the first circumferential direction C1. The upper cam surface 131b is inclined upward as it advances in the first circumferential direction C1. The lower end of the upper cam surface 131b is connected to the upper end of the lower cam surface 131a. The contact surface 131c extends in the vertical direction Z. The contact surface 131c connects the lower end of the lower cam surface 131a and the upper end of the upper cam surface 131b. The inclination of the lower cam surface 131a with respect to the vertical direction Z is equal to the inclination of the lower sliding surface 52a of the lower guide 50 in the vertical direction Z. Similarly, the inclination of the upper cam surface 131b with respect to the vertical direction Z is equal to the inclination of the upper sliding surface 62a of the upper guide 60 with respect to the vertical direction Z.

The two engaging recesses 132 are recessed from the outer peripheral surface of the boss base 130 toward the axis of the boss base 130. The two engaging recesses 132 are provided over the vertical direction Z of the boss base 130. Therefore, the outer peripheral surface of the boss base 130 is separated by the two engaging recesses 132 in the circumferential direction C. The two engaging recesses 132 are arranged at equal intervals in the circumferential direction C.

As illustrated in FIGS. 3 and 4, the stopper ring 140 has an annular shape. The axial direction and the plate thickness direction of the stopper ring 140 are both the vertical direction Z. The plate thickness of the stopper ring 140 is constant. The stopper ring 140 is, for example, a resin molded product.

### Rotary 160

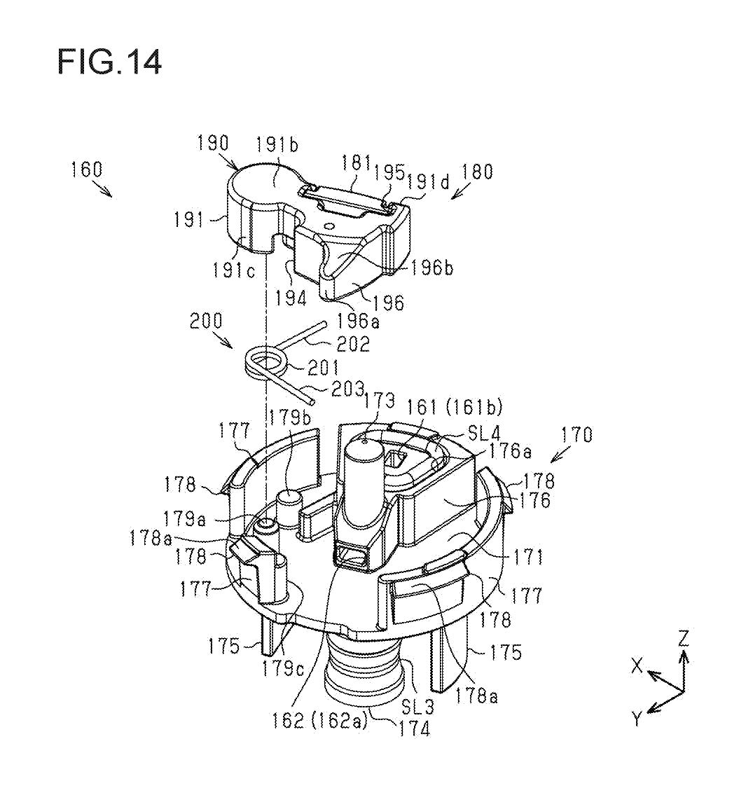

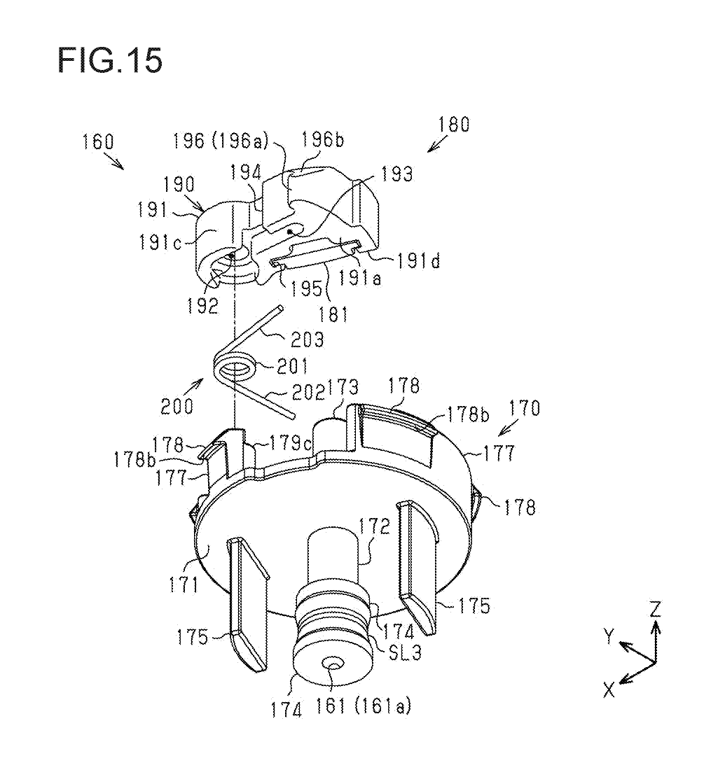

As illustrated in FIGS. 3, 4, and 14 to 17, the rotary 160 includes a rotary main body 170, an on-off valve 180, a torsion spring 200, a third seal SL3, and a fourth seal SL4. The rotary 160 also has an air-supply flow path 161 and an exhaust flow path 162. The third seal SL3 and the fourth seal SL4 are formed of, for example, an elastomer such as rubber. The fourth seal SL4 corresponds to a “seal”.

The rotary main body 170 has a bottom wall 171, a lower shaft portion 172, an upper shaft portion 173, two support flanges 174, two transmission shafts 175, a flow-path forming portion 176, a plurality of elastic walls 177, and a plurality of claw portions 178. The rotary main body 170 also has a link support shaft 179a, a first engaging shaft 179b, and a second engaging shaft 179c. The rotary main body 170 is, for example, a resin molded product.

The bottom wall 171 has a disk shape. The axial direction of the bottom wall 171 is the vertical direction Z. The lower shaft portion 172 and the upper shaft portion 173 have cylindrical shapes. The axial direction of the lower shaft portion 172 and the axial direction of the upper shaft portion 173 are the vertical direction Z. The lower shaft portion 172 extends downward from the central portion of the lower surface of the bottom wall 171. On the other hand, the upper shaft portion 173 extends upward from the central portion of the upper surface of the bottom wall 171. The axis of the upper shaft portion 173 coincides with the axis of the lower shaft portion 172.

The two support flanges 174 extend radially outward from the lower shaft portion 172. The two support flanges 174 are spaced apart from each other in the vertical direction Z. The third seal SL3 is disposed between the two support flanges 174. The two support flanges 174 restrict the third seal SL3 from moving in the vertical direction Z with respect to the rotary main body 170. The two transmission shafts 175 extend downward from the lower surface of the bottom wall 171. The two transmission shafts 175 are arranged at equal intervals in the circumferential direction C.

The flow-path forming portion 176 extends upward from the upper surface of the bottom wall 171. The flow-path forming portion 176 has a recessed groove 176a recessed downward from the upper surface of the flow-path forming portion 176. When the rotary main body 170 is viewed from above, the recessed groove 176a has a frame shape. The fourth seal SL4 is fitted into the recessed groove 176a.

The plurality of elastic walls 177 extend in the plate thickness direction of the bottom wall 171 from the peripheral edge of the bottom wall 171. The extending direction of the plurality of elastic walls 177 is an upward direction. The plurality of elastic walls 177 is provided at intervals in the circumferential direction C. In the present embodiment, the lengths of the plurality of elastic walls 177 in the circumferential direction C are different from each other, but in other embodiments, the lengths of the plurality of elastic walls 177 in the circumferential direction C may be constant. In addition, the elastic wall 177 is elastically deformable because the rotary main body 170 is a resin molded product.

The plurality of claw portions 178 constitute the outermost peripheral portion in the radial direction of the rotary main body 170. The plurality of claw portions 178 extend radially outward from the flow-path forming portion 176 and the plurality of elastic walls 177, respectively. The plurality of claw portions 178 are provided at intervals in the circumferential direction C. The length in the vertical direction Z of the claw portion 178 gradually decreases as it advances radially outward. Specifically, an inclined surface 178a and a locking surface 178b are included. The inclined surface 178a is the upper surface of the claw portion 178 and is a surface inclined with respect to the vertical direction Z. Specifically, the inclined surface 178a is inclined upward as it advances toward the rotational axis of the rotary 160 in the radial direction. The locking surface 178b is the lower surface of the claw portion 178 and is a plane orthogonal to the vertical direction Z. Two claw portions 178 are provided in the flow-path forming portion 176. In the flow-path forming portion 176, the claw portion 178 is provided near the upper end of the outer peripheral surface of the flow-path forming portion 176. In addition, the elastic wall 177 having a long length in the circumferential direction C is provided with two claw portions 178, and the elastic wall 177 having a short length in the circumferential direction C is provided with one claw portion 178. In the elastic wall 177, the claw portion 178 is provided near the upper end of the outer peripheral surface of the elastic wall 177. In the flow-path forming portion 176 and the plurality of elastic walls 177, the formation positions in the vertical direction Z of the claw portions 178 are equal to each other. The claw portion 178 corresponds to an “engaging portion”.

In the radial direction, the distance from the rotational axis of the rotary 160 to the tips of the plurality of claw portions 178 is longer than the distance from the axis of the valve case 70 to the third sliding surface 72c of the sliding wall 72. That is, in the radial direction, the outer diameter of a portion of the rotary 160 where the plurality of claw portions 178 are provided is larger than the inner diameter of a portion of the sliding wall 72 of the valve case 70 where the third sliding surface 72c is provided.

The link support shaft 179a, the first engaging shaft 179b, and the second engaging shaft 179c have cylindrical shapes. The axial directions of the link support shaft 179a, the first engaging shaft 179b, and the second engaging shaft 179c are the vertical direction Z. The link support shaft 179a, the first engaging shaft 179b, and the second engaging shaft 179c extend upward from the bottom wall 171 at positions shifted from the flow-path forming portion 176. When the rotary main body 170 is viewed from above, the link support shaft 179a is positioned between the first engaging shaft 179b and the second engaging shaft 179c. The second engaging shaft 179c is integrated with one of the plurality of elastic walls 177.

The air-supply flow path 161 is provided over the bottom wall 171, the lower shaft portion 172, and the flow-path forming portion 176 of the rotary main body 170. The air-supply flow path 161 opens at the lower surface of the lower shaft portion 172 and the upper surface of the flow-path forming portion 176. Hereinafter, the upstream end of the air-supply flow path 161 that opens at the lower surface of the lower shaft portion 172 is referred to as an air-supply port 161a. The downstream end of the air-supply flow path 161 that opens at the upper surface of the flow-path forming portion 176 is referred to as a connection port 161b. As viewed from above, the connection port 161b of the air-supply flow path 161 is surrounded by the fourth seal SL4. The exhaust flow path 162 is provided in the flow-path forming portion 176. The exhaust flow path 162 is a flow path that connects the air-supply flow path 161 and the outside air. Hereinafter, an opening of the exhaust flow path 162 that is connected to the outside air is referred to as an exhaust port 162a. The exhaust port 162a opens radially outward in the flow-path forming portion 176.

The on-off valve 180 has a valve body 181 and a link arm 190.

The valve body 181 is preferably formed of an elastomer such as rubber or resin having appropriate elasticity. The shape of the valve body 181 may be any shape as long as it can close the exhaust port 162a of the rotary main body 170.

The link arm 190 has an arm main body 191 and a sliding portion 196. In the link arm 190, the arm main body 191 and the sliding portion 196 are integrally molded. The link arm 190 is, for example, a resin molded product. The link arm 190 has a rod shape. In the plate thickness direction that is a direction orthogonal to the longitudinal direction of the link arm 190, the outer shape of the link arm 190 is substantially constant.

The arm main body 191 constitutes most of the link arm 190. In this respect, the longitudinal direction of the arm main body 191 is the same as the longitudinal direction of the link arm 190. The arm main body 191 includes an arm lower surface 191a and an arm upper surface 191b, which are surfaces intersecting the plate thickness direction, and a first side surface 191c and a second side surface 191d, which are surfaces along the plate thickness direction.

The arm main body 191 also includes a shaft hole 192, an accommodating groove 193, a recess 194, and a holding groove 195. The shaft hole 192 is provided at the base end portion in the longitudinal direction of the arm main body 191. The shaft hole 192 is recessed from the arm lower surface 191a toward the arm upper surface 191b. The shaft hole 192 is a circular hole. The accommodating groove 193 is provided from the base end portion to the tip portion of the arm main body 191. The accommodating groove 193 is recessed from the arm lower surface 191a toward the arm upper surface 191b. The accommodating groove 193 is connected to the shaft hole 192. The recess 194 is recessed from the first side surface 191c toward the second side surface 191d of the arm main body 191. The recess 194 is connected to the accommodating groove 193. In the arm main body 191, the holding groove 195 is provided on the second side surface 191d, and provided closer to the tip portion than to the base end portion of the arm main body 191. The holding groove 195 penetrates the arm main body 191 in the plate thickness direction. The valve body 181 is fitted into the holding groove 195. In this way, the link arm 190 holds the valve body 181.

The sliding portion 196 is provided on the first side surface 191c of the arm main body 191, and provided at the tip portion of the arm main body 191. The sliding portion 196 protrudes from the arm main body 191. The sliding portion 196 has a pressing surface 196a constituting the tip of the sliding portion 196, and a pressure-receiving surface 196b constituting the upper surface of the sliding portion 196. The pressing surface 196a is a convex curved surface with respect to the protruding direction of the sliding portion 196. The pressure-receiving surface 196b is connected to the arm upper surface 191b. The pressure-receiving surface 196b is inclined with respect to the protruding direction of the sliding portion 196. Therefore, the length in the plate thickness direction of the sliding portion 196 gradually decreases as it advances in the protruding direction.

The on-off valve 180 is rotatably supported by the rotary main body 170. Specifically, the link support shaft 179a of the rotary main body 170 is inserted into the shaft hole 192 of the link arm 190. In this way, the on-off valve 180 is rotatable about the axis of the link support shaft 179a. In a state where the on-off valve 180 is supported by the rotary main body 170, the valve body 181 faces the exhaust port 162a of the rotary main body 170 in the rotational direction of the link arm 190. Therefore, when the on-off valve 180 rotates so that the valve body 181 approaches the exhaust port 162a, the valve body 181 is displaced to a closed position where the exhaust port 162a is closed. On the other hand, when the on-off valve 180 rotates so that the valve body 181 is spaced apart from the exhaust port 162a, the valve body 181 is displaced to an open position where the exhaust port 162a is opened. In the following description, a rotational direction in which the on-off valve 180 moves from the open position to the closed position is referred to as a “closing direction”, and a rotational direction in which the on-off valve 180 moves from the closed position to the open position is referred to as an “opening direction”. The closing direction is an opposite direction to the opening direction. In a state where the on-off valve 180 is supported by the rotary main body 170, the recess 194 of the link arm 190 opens toward the second engaging shaft 179c of the rotary main body 170 in the rotational direction of the link arm 190.

The torsion spring 200 has a coil portion 201, a first arm 202 extending from a first end of the coil portion 201, and a second arm 203 extending from a second end of the coil portion 201. The length of the first arm 202 is equal to the length of the second arm 203. The torsion spring 200 is supported by the rotary main body 170. Specifically, the link support shaft 179a of the rotary main body 170 is inserted into the coil portion 201 of the torsion spring 200. The first arm 202 of the torsion spring 200 is engaged with the first engaging shaft 179b of the rotary main body 170, and the second arm 203 of the torsion spring 200 is engaged with the second engaging shaft 179c of the rotary main body 170. The coil portion 201, the base end portion of the first arm 202, and the second arm 203 of the torsion spring 200 are accommodated in the accommodating groove 193 of the link arm 190.

When the on-off valve 180 rotates in the closing direction, the on-off valve 180 rotates in the closing direction together with the second arm 203 of the torsion spring 200. That is, when the on-off valve 180 rotates in the closing direction, the torsion spring 200 is elastically deformed. In this way, the on-off valve 180 is biased in the opening direction.

### Mounting Configuration of Rotary 160 on Valve Case 70

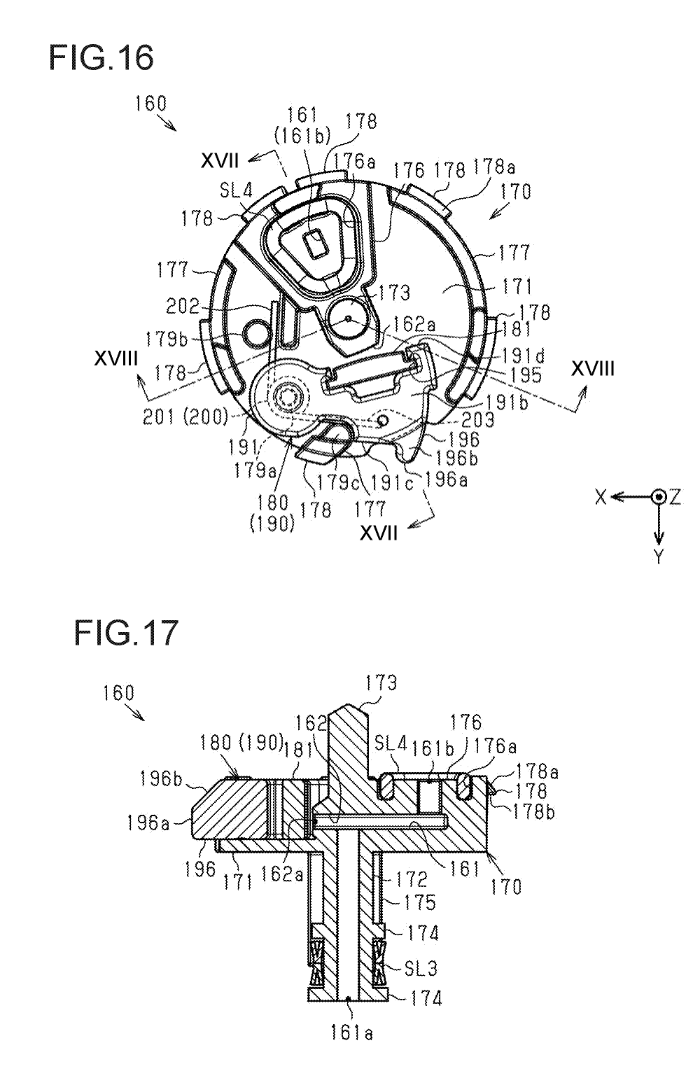

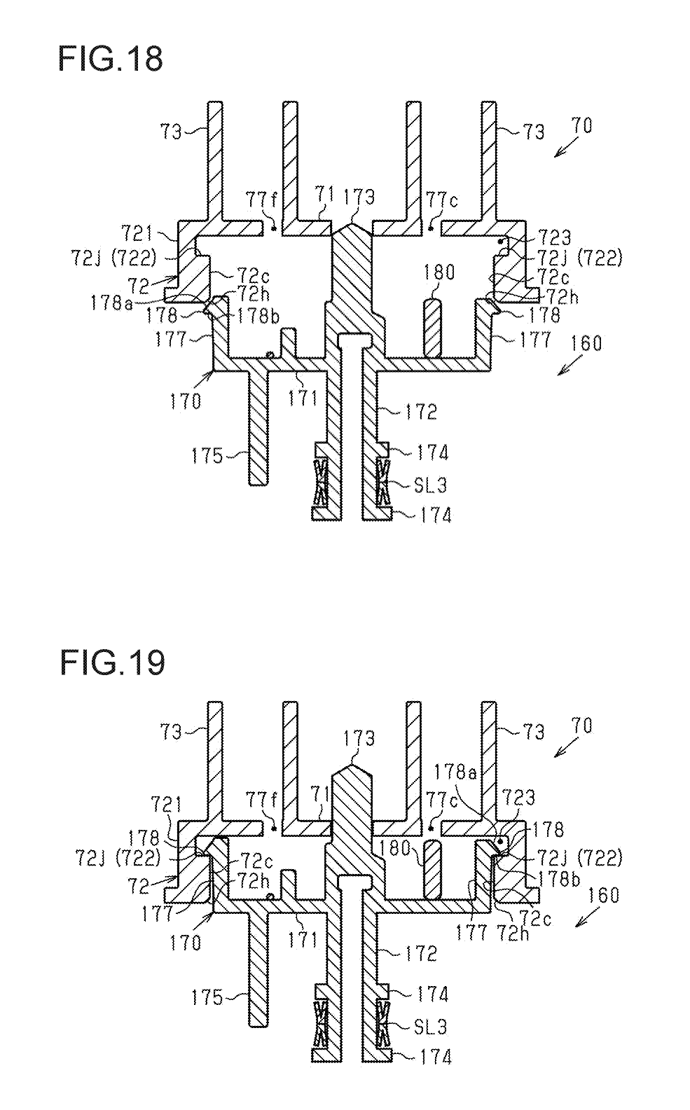

When the rotary valve 30 is assembled, the rotary 160 is mounted on the valve case 70 in advance. Hereinafter, a mounting configuration of the rotary 160 on the valve case 70 will be described with reference to FIGS. 18 and 19. In the following description, attention is paid to one elastic wall 177 and one claw portion 178 among the plurality of elastic walls 177 and the plurality of claw portions 178 of the rotary 160, and attention is paid to one sliding projection 722 among the eight sliding projections 722 of the valve case 70. The cross section of the rotary 160 illustrated in FIGS. 18 and 19 is a cross section taken along line XVIII-XVIII in FIG. 16. The cross section of the valve case 70 illustrated in FIGS. 18 and 19 is a cross section corresponding to a cross section taken along line XVIII-XVIII in FIG. 16.

When the rotary 160 is mounted on the valve case 70, the rotary 160 is inserted into the valve case 70 along the axial direction in a state where the axis of the valve case 70 and the axis of the rotary 160 are aligned, as illustrated in FIGS. 18 and 19. Then, the upper shaft portion 173 of the rotary 160 is inserted into the shaft hole 71a of the valve case 70. As a result, the rotary 160 is positioned with respect to the valve case 70 in a direction orthogonal to the insertion direction of the rotary 160. Subsequently, the inclined surface 178a of the claw portion 178 of the rotary 160 comes into contact with the insertion guide surface 72h of the sliding wall 72 of the valve case 70. Therefore, as the insertion amount of the rotary 160 increases, the inclined surface 178a of the claw portion 178 of the rotary 160 more slides against the insertion guide surface 72h of the valve case 70. As a result, the claw portion 178 of the rotary 160 is guided toward the axis of the valve case 70, and the elastic wall 177 of the rotary 160 is elastically deformed toward the axis of the valve case 70.

When the insertion amount of the rotary 160 further increases, sliding between the claw portion 178 of the rotary 160 and the sliding wall 72 of the valve case 70 is completed. Then, the elastic wall 177 of the rotary 160 is restored, and the claw portion 178 of the rotary 160 is accommodated in the accommodating groove 723 of the valve case 70. As a result, the claw portion 178 of the rotary 160 is locked to the holding surface 72j of the valve case 70. That is, in the vertical direction Z, the locking surface 178b of the claw portion 178 of the rotary 160 comes into contact with the holding surface 72j of the valve case 70. In a state where the claw portion 178 of the rotary 160 is locked to the holding surface 72j of the valve case 70, the fourth seal SL4 of the rotary 160, in an elastically compressed state, is in contact with the opening surface 71b of the valve case 70. In this way, the rotary 160 is not movable in the axial direction with respect to the valve case 70. On the other hand, the accommodating groove 723 of the valve case 70, in which the claw portion 178 of the rotary 160 is accommodated, has an annular shape. That is, the valve case 70 does not have a member that interferes with the claw portion 178 in the circumferential direction C. Therefore, the rotary 160 is rotatable in the circumferential direction C with respect to the valve case 70.

In a state where the claw portion 178 of the rotary 160 is locked to the holding surface 72j of the valve case 70, the upper portion of the rotary 160 is covered with the sliding wall 72 of the valve case 70 from the outside in the radial direction. The connection port 161b of the rotary 160 faces the opening surface 71b of the valve case 70.

### Engagement Relationship Between Components of Rotary Valve 30

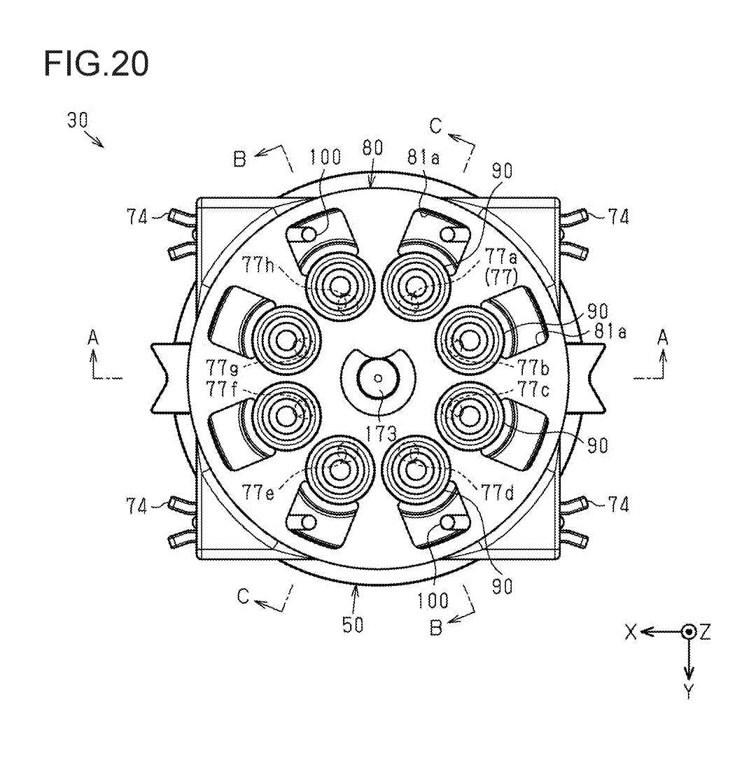

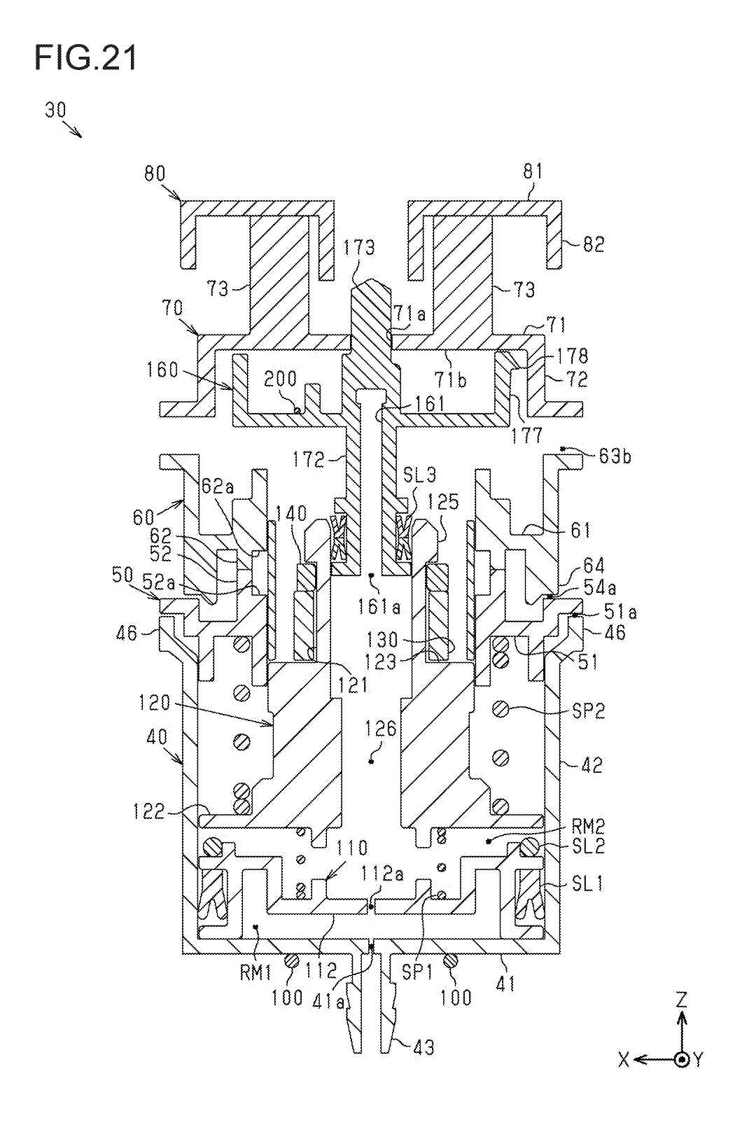

The engagement relationship between the components of the rotary valve 30 will be described with reference to FIGS. 3, 4, 20, and 21. FIGS. 20 and 21 illustrate a state after the rotary valve 30 is assembled.

Engagement relationship between components outside the rotary valve 30 will be described.

As illustrated in FIGS. 3, 4, and 21, the lower guide 50 is stacked above the cylinder 40. The two positioning projections 46 of the cylinder 40 are inserted into the two positioning recesses 51a of the lower guide 50, respectively. As a result, the lower guide 50 is not rotatable in the circumferential direction C with respect to the cylinder 40.

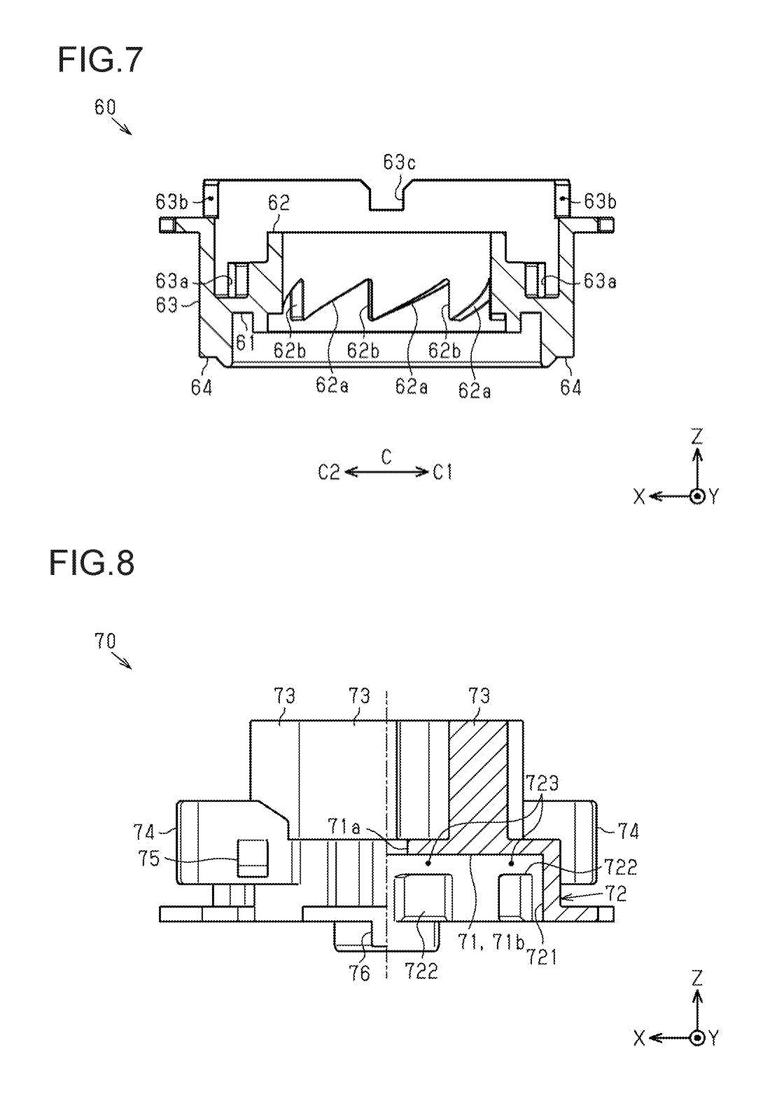

The upper guide 60 is stacked above the lower guide 50. The two positioning projections 64 of the upper guide 60 are inserted into the two positioning recesses 54a of the lower guide 50, respectively. As a result, the upper guide 60 is not rotatable in the circumferential direction C with respect to the lower guide 50. The lower guide 50 and the upper guide 60 are stacked while remaining in the state illustrated in FIGS. 6 and 7. Therefore, in the vertical direction Z, the plurality of upper sliding surfaces 62a of the upper guide 60 face the plurality of lower sliding surfaces 52a of the lower guide 50. Specifically, the upper sliding surface 62a of the upper guide 60 is shifted in the circumferential direction C with respect to the lower sliding surface 52a of the lower guide 50. That is, in the vertical direction Z, one upper sliding surface 62a of the upper guide 60 faces two lower sliding surfaces 52a of the lower guide 50. In other words, one lower sliding surface 52a of the lower guide 50 faces two upper sliding surfaces 62a of the upper guide 60.

As illustrated in FIGS. 3, 4, and 21, the valve case 70 is stacked above the upper guide 60. As illustrated in FIGS. 3 and 4, the two positioning projections 76 of the valve case 70 are inserted into the two positioning recesses 63c of the upper guide 60, respectively. As a result, the valve case 70 is not rotatable in the circumferential direction C with respect to the upper guide 60.

As illustrated in FIG. 2, the two clamps 100 are locked to the cylinder 40 and the valve case 70. Specifically, the lower end portions of the clamps 100 are locked to the two lower clamp holders 44 and the two lower clamp guides 45 of the cylinder 40. On the other hand, the upper end portions of the clamps 100 are locked to the two upper clamp holders 74 of the valve case 70. In this way, the two clamps 100 sandwich the cylinder 40, the lower guide 50, the upper guide 60, and the valve case 70, which are stacked, in the vertical direction Z. Here, no seal member such as a packing is disposed between the cylinder 40, the lower guide 50, the upper guide 60, and the valve case 70, which are stacked in the vertical direction Z. Therefore, a slight gap allowing air to pass therethrough exists between the cylinder 40, the lower guide 50, the upper guide 60, and the valve case 70.

As illustrated in FIGS. 2 to 4 and 21, the nozzle holder 80 is mounted above the valve case 70. Specifically, the four locking walls 84 of the nozzle holder 80 are locked to the four locking protrusions 75 of the valve case 70, respectively. That is, the four locking protrusions 75 of the valve case 70 are accommodated in the four locking holes 84a of the nozzle holder 80, respectively. As described above, the nozzle holder 80 is mounted on the valve case 70 by so-called snap fit. When the nozzle holder 80 is mounted on the valve case 70, the eight upper nozzles 90 are inserted into the eight cylindrical walls 73 of the valve case 70, respectively. In this way, the eight upper nozzles 90 are connected to the eight connecting flow paths 77 of the valve case 70, respectively.

As illustrated in FIG. 1, the upstream ends of the eight connecting tubes 22 are connected to the rotary valve 30 via the eight upper nozzles 90. As a result, the downstream ends of the eight connecting flow paths 77 are connected to the eight air bags 21 via the eight upper nozzles 90 and the eight connecting tubes 22, respectively.

Engagement relationship between the components inside the rotary valve 30 will be described.

As illustrated in FIGS. 3, 4, and 21, the lower piston 110 is accommodated in the cylinder 40 so as to be movable in the vertical direction Z. The lower piston 110 faces the bottom wall 41 of the cylinder 40 in the vertical direction Z. The first seal SL1 of the lower piston 110 is in contact with the peripheral wall 42 of the cylinder 40. In this way, the lower piston 110 defines the first air chamber RM1 together with the cylinder 40. The first air chamber RM1 is connected to the communication hole 41a and the communication flow path 112a. The lower piston 110 illustrated in FIG. 21 is located at an initial position PL0 that is the lowest position in the movement range in the vertical direction Z. The lower piston 110 is in contact with the bottom wall 41 of the cylinder 40 at the initial position PL0. The first air chamber RM1 corresponds to the “air chamber”.

The center piston 120 is accommodated in the cylinder 40, the lower guide 50, and the upper guide 60 so as to be movable in the vertical direction Z. When the center piston 120 moves up and down, at least a part in the circumferential direction C of the sliding flange 122 slides against the peripheral wall 42 of the cylinder 40. However, a slight gap allowing air to pass therethrough exists between the sliding flange 122 of the center piston 120 and the peripheral wall 42 of the cylinder 40. The center piston 120 is located above the lower piston 110. The center piston 120 and the lower piston 110 define a second air chamber RM2. The second air chamber RM2 is connected to the first air chamber RM1 through the communication flow path 112a and is connected to the internal flow path 126 of the center piston 120. Furthermore, the lower piston 110 is spaced apart from the center piston 120 in the state illustrated in FIG. 21, and thus the second air chamber RM2 is connected to the outside air. Specifically, the second air chamber RM2 is connected to the outside air via the gap between the cylinder 40 and the lower guide 50. The center piston 120 illustrated in FIG. 21 is located at an initial position PC0 that is the lowest position in the movement range in the vertical direction Z. The second air chamber RM2 corresponds to the “air chamber”.

The lower spring SP1 is disposed, in a compressed state in the vertical direction Z, between the bottom wall 112 of the lower piston 110 and the sliding flange 122 of the center piston 120. That is, the lower spring SP1 biases the lower piston 110 and the center piston 120 in a direction in which they are spaced apart from each other. In other words, the lower spring SP1 biases the lower piston 110 in a direction in which the lower piston 110 descends and in a direction in which the volume of the first air chamber RM1 decreases. In addition, the lower spring SP1 biases the center piston 120 in a direction in which the center piston 120 is raised and in a direction in which the volume of the second air chamber RM2 increases.

The center spring SP2 is disposed, in a compressed state in the vertical direction Z, between the sliding flange 122 of the center piston 120 and the intermediate wall 51 of the lower guide 50. That is, the center spring SP2 biases the center piston 120 in a direction in which the center piston 120 descends and in a direction in which the volume of the second air chamber RM2 decreases.

The boss base 130 and the stopper ring 140 are supported by the center piston 120. Specifically, the shaft portion 121 of the center piston 120 is inserted into the boss base 130 and the stopper ring 140. At this time, the boss base 130 is in contact with the support flange 123 of the center piston 120, and the stopper ring 140 is engaged with the two protruding portions 125 of the center piston 120. In this way, the stopper ring 140 sandwiches the boss base 130 in the vertical direction Z together with the center piston 120. As a result, the boss base 130 is movable in the vertical direction Z together with the center piston 120. In other words, the boss base 130 is not movable in the vertical direction Z with respect to the center piston 120. On the other hand, the boss base 130 is rotatable in the circumferential direction C with respect to the center piston 120. The boss base 130 is located between the center piston 120 and the lower guide 50 and the upper guide 60 in the radial direction. Although not illustrated, the six bosses 131 of the boss base 130 are positioned between the plurality of lower sliding surfaces 52a of the lower guide 50 and the plurality of upper sliding surfaces 62a of the upper guide 60 in the vertical direction Z.

The rotary 160 is accommodated in the upper guide 60 and the valve case 70 so as to be rotatable in the circumferential direction C. The lower shaft portion 172 of the rotary 160 is inserted into the shaft portion 121 of the center piston 120. The third seal SL3 of the rotary 160 is in contact with the inner peripheral surface of the shaft portion 121 of the center piston 120. In this way, the air-supply flow path 161 of the rotary 160 is connected to the second air chamber RM2 through the internal flow path 126 of the center piston 120.

As illustrated in FIGS. 3 and 4, the two transmission shafts 175 of the rotary 160 are inserted into the two engaging recesses 132 of the boss base 130, respectively. Therefore, the rotary 160 is rotatable in the circumferential direction C together with the center piston 120 and the boss base 130. In other words, the rotary 160 is not rotatable in the circumferential direction C with respect to the center piston 120 and the boss base 130. On the other hand, the rotary 160 is movable in the vertical direction Z with respect to the center piston 120 and the boss base 130. To be precise, the rotary 160 is not movable in the vertical direction Z, and thus the center piston 120 and the boss base 130 are movable in the vertical direction Z with respect to the rotary 160.

As illustrated in FIGS. 3, 4, 21, and 22, the upper shaft portion 173 of the rotary 160 is inserted into the shaft hole 71a of the valve case 70. In this way, the rotary 160 is rotatable in the circumferential direction C with respect to the valve case 70 and the center piston 120. In addition, the rotary 160 is locked to the eight sliding projections 722 of the valve case 70 via the plurality of claw portions 178. In this way, the rotary 160 is not movable in the vertical direction Z with respect to the valve case 70. When the rotary 160 rotates, a certain claw portion 178 of the rotary 160 slides sequentially against the eight rotation guide surfaces 72i and the eight holding surfaces 72j of the valve case 70.

Here, the number of the claw portions 178 formed in the rotary 160 is different from the number of the sliding projections 722 formed in the valve case 70. In addition, in the circumferential direction C, the formation interval between the plurality of claw portions 178 in the rotary 160 is different from the formation interval between the eight sliding projections 722 in the valve case 70. Furthermore, in the circumferential direction C, the formation length of the claw portion 178 in the rotary 160 is different from the formation length of the sliding projection 722 in the valve case 70. In these respects, not all the claw portions 178 of the rotary 160 are locked to the valve case 70, regardless of the rotational position of the rotary 160. However, it is preferable that, regardless of the rotational position of the rotary 160, two or more claw portions 178, preferably three or more claw portions 178 are locked to the valve case 70. In addition, it is preferable that the engagement points between the claw portions 178 and the valve case 70 are dispersed without being biased in the circumferential direction C.

In a state where the plurality of claw portions 178 of the rotary 160 are locked to the valve case 70, the fourth seal SL4 of the rotary 160 is compressed and deformed between the holding groove 195 of the rotary 160 and the opening surface 71b of the valve case 70. Therefore, when the rotary 160 rotates, the fourth seal SL4 of the rotary 160 slides against the opening surface 71b of the valve case 70.

The sliding portion 196 of the on-off valve 180 of the rotary 160 is biased radially toward the sliding wall 72 of the valve case 70. Therefore, when the rotary 160 rotates, the sliding portion 196 of the on-off valve 180 of the rotary 160 slides against the sliding wall 72 of the valve case 70.

### Operation of Present Embodiment

### Basic Operation of Rotary Valve 30

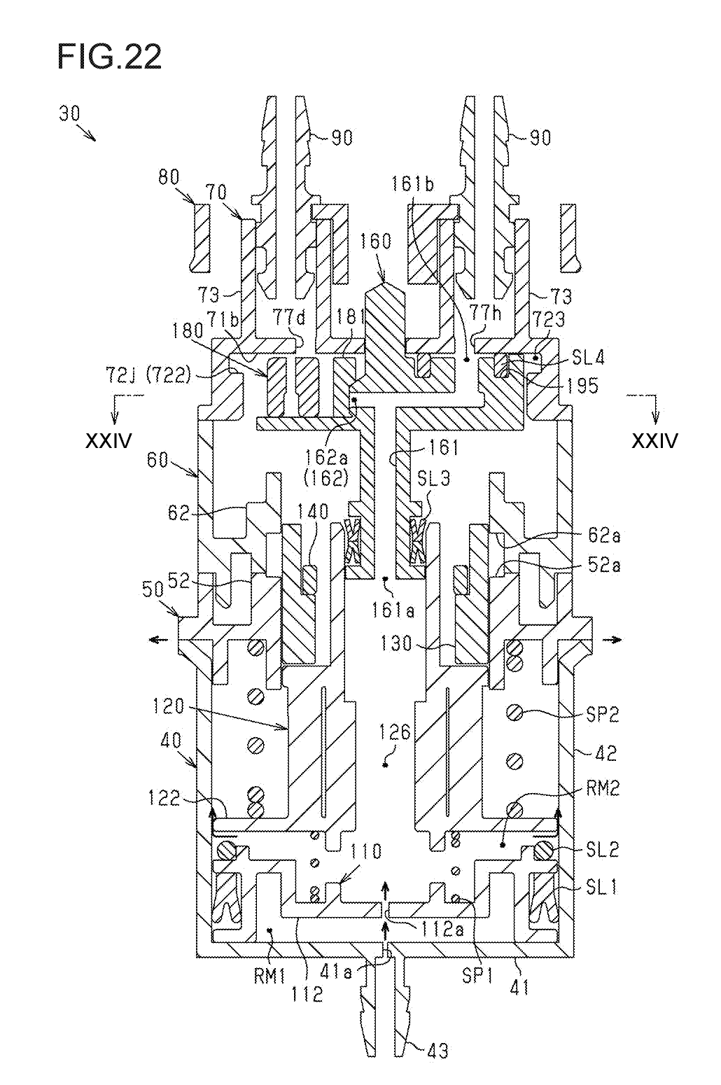

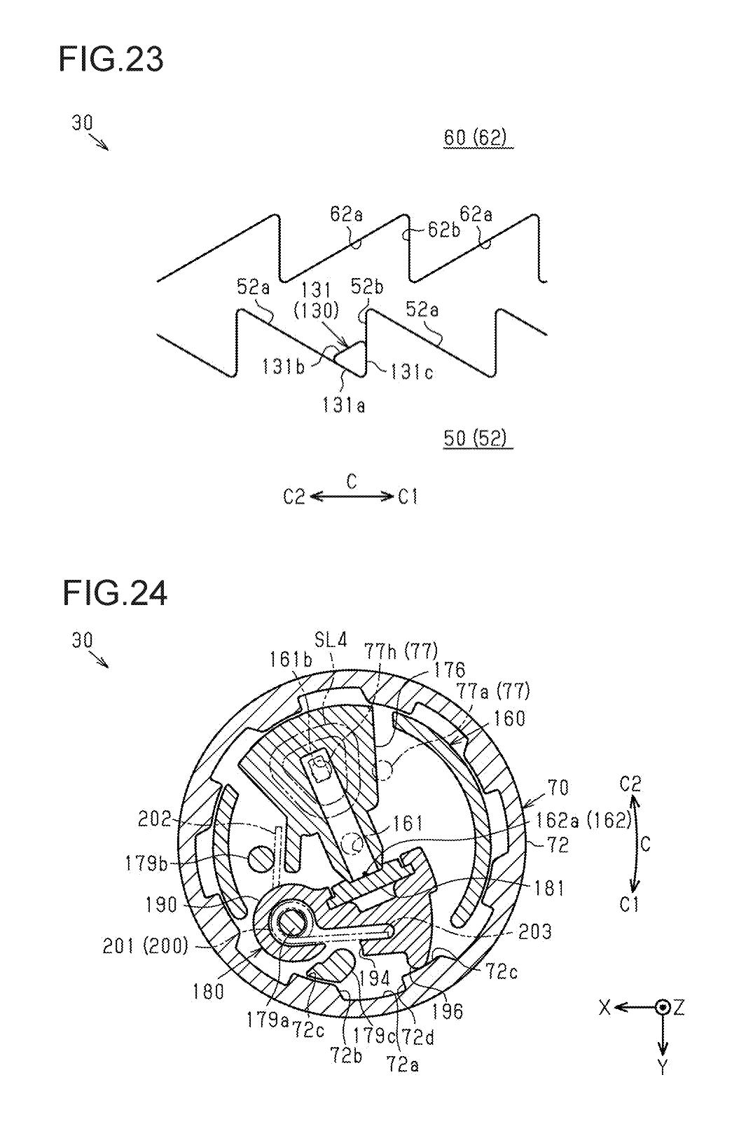

With reference to FIGS. 22 to 32, the basic operation of the rotary valve 30, when the drive of the pump 24 is started in a situation where the rotary valve 30 is in the initial state illustrated in FIG. 22, will be described. The initial state of the rotary valve 30 illustrated in FIG. 22 is an example. The initial state of the rotary valve 30 may change depending on the state of the rotary valve 30 when the drive of the pump 24 was stopped in the previous cycle. FIGS. 23, 27, and 31 are schematic views obtained by extracting a part of the inner peripheral wall 52 of the lower guide 50, a part of the inner peripheral wall 62 of the upper guide 60, and the boss 131 of the boss base 130.

In the initial state, the lower piston 110 is located at the initial position PL0 that is the lowest in the movement range in the vertical direction Z, as illustrated in FIG. 22. The lower piston 110 is in contact with the bottom wall 41 of the cylinder 40 at the initial position PL0.

In the initial state, the center piston 120 is located at the initial position PC0 that is the lowest in the movement range in the vertical direction Z. Therefore, the boss base 130 that moves up and down together with the center piston 120 is also lowest in the movement range in the vertical direction Z. In the initial state, the boss 131 of the boss base 130 is in contact with both the lower sliding surface 52a and the lower restricting surface 52b of the lower guide 50, as illustrated in FIG. 23. When the boss 131 of the boss base 130 is in contact with both the lower sliding surface 52a and the lower restricting surface 52b of the lower guide 50, the rotary 160 is located at the position illustrated in FIG. 24. That is, the sliding portion 196 of the on-off valve 180 is in contact with the third sliding surface 72c of the valve case 70, and thus the on-off valve 180 is located at the closed position. That is, the rotary 160 is in the air-supply state where the exhaust flow path 162 is not connected to the outside air.

In the initial state, the second air chamber RM2 is connected to one air bag 21h via the internal flow path 126 of the center piston 120, the air-supply flow path 161 of the rotary 160, the connecting flow path 77h of the valve case 70, the upper nozzle 90, and the connecting tube 22, as illustrated in FIG. 22. Since the on-off valve 180 of the rotary 160 is located at the closed position, the air-supply flow path 161 of the rotary 160 is not connected to the outside air. On the other hand, the lower piston 110 is not in contact with the center piston 120, and thus the second air chamber RM2 is connected to the outside air. Therefore, in the initial state, the air bag 21h is connected to the outside air, and thus the pressure in the air bag 21h is equal to the outside air pressure. That is, the air bag 21h is contracting in the initial state. In the initial state, the biasing force of the lower spring SP1 acting on the lower piston 110 is smaller than the biasing force of the center spring SP2 acting on the center piston 120.

When the pump 24 is driven, supply of air to the first air chamber RM1 is started through the communication hole 41a of the cylinder 40, as indicated by the solid-line arrow in FIG. 22. Then, air is supplied from the first air chamber RM1 to the second air chamber RM2 through the communication flow path 112a of the lower piston 110. Here, the inner diameter of the communication flow path 112a of the lower piston 110 is small, and thus the flow rate of the air flowing into the second air chamber RM2 through the communication flow path 112a is smaller than the flow rate of the air flowing into the first air chamber RM1 through the communication hole 41a. That is, the communication flow path 112a of the lower piston 110 limits the flow rate of the air flowing from the first air chamber RM1 into the second air chamber RM2. Therefore, the pressure in the first air chamber RM1 increases in accordance with an elapsed time after the pump 24 is driven. On the other hand, the air supplied to the second air chamber RM2 is discharged to the outside air through the gap between the lower piston 110 and the center piston 120 and the gap between the cylinder 40 and the lower guide 50. Therefore, the pressure in the second air chamber RM2 does not substantially increase.

In the present embodiment, the inner diameter of the communication hole 41a of the cylinder 40 is small, and thus the flow rate of the air flowing into the first air chamber RM1 through the communication hole 41a is smaller than the flow rate of the air delivered by the pump 24. That is, the communication hole 41a of the cylinder 40 limits the flow rate of the air flowing into the first air chamber RM1.

As the pressure in the first air chamber RM1 increases and when the upward force acting on the lower piston 110 becomes larger than the downward force acting on the lower piston 110, the lower piston 110 starts to rise. Here, the upward force acting on the lower piston 110 is the product of the pressure in the first air chamber RM1 and the pressure-receiving area of the lower piston 110 on which the pressure acts. On the other hand, the downward force acting on the lower piston 110 is the sum of the product of the pressure in the second air chamber RM2 and the pressure-receiving area of the lower piston 110 on which the pressure acts and the biasing force of the lower spring SP1.

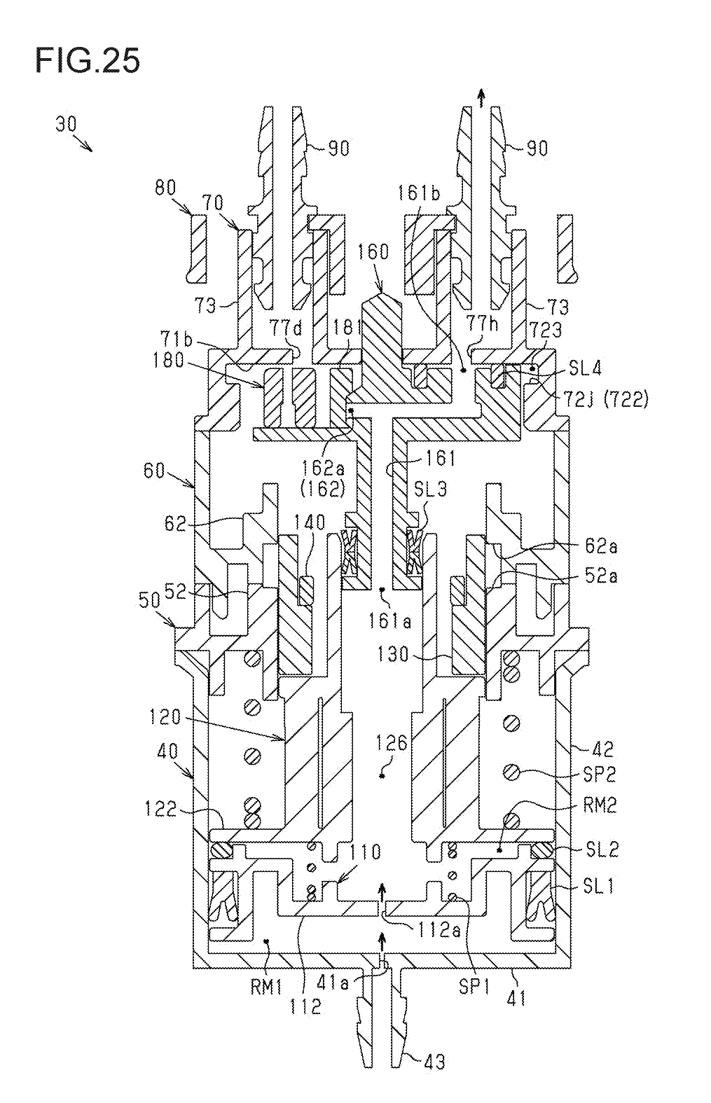

When the lower piston 110 rises, the second seal SL2 of the lower piston 110 comes into contact with the sliding flange 122 of the center piston 120, as illustrated in FIG. 25. Thereafter, when the lower piston 110 further rises, the second seal SL2 of the lower piston 110 is compressed. That is, the second seal SL2 of the lower piston 110 is in close contact with the sliding flange 122 of the center piston 120. As a result, the second air chamber RM2 is shielded from the outside air.

When the lower piston 110 comes into contact with the center piston 120, the air flowing into the second air chamber RM2 does not flow out to the outside air. As a result, the air flowing into the second air chamber RM2 is supplied to one air bag 21h via the internal flow path 126 of the center piston 120, the air-supply flow path 161 of the rotary 160, the connecting flow path 77h of the valve case 70, the upper nozzle 90, and the connecting tube 22. That is, the air bag 21h expands. In addition, the pressure in the first air chamber RM1 and the pressure in the second air chamber RM2 increase, and the pressures in the space and the flow path connected to the second air chamber RM2 increase. As described above, the communication flow path 112a of the lower piston 110 limits the flow rate of the air flowing from the first air chamber RM1 to the second air chamber RM2. Therefore, the pressure in the first air chamber RM1 is maintained higher than the pressure in the second air chamber RM2.

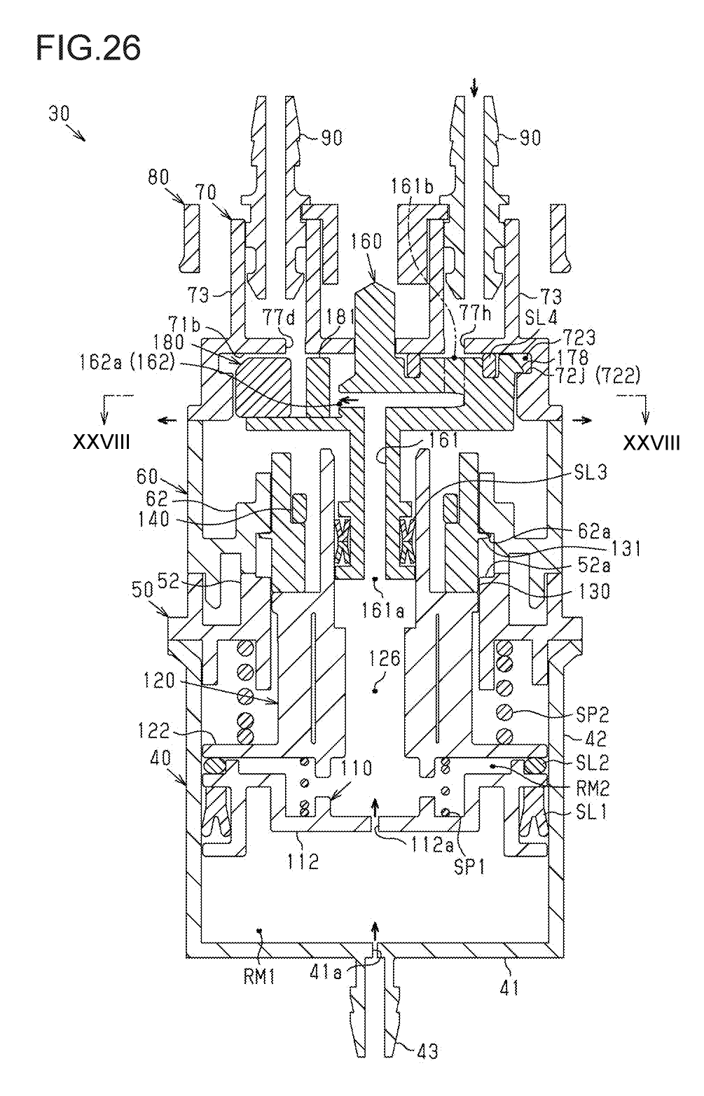

As the pressure in the first air chamber RM1 increases and when the upward force acting on the lower piston 110 and the center piston 120 becomes larger than the downward force acting on the lower piston 110 and the center piston 120, the lower piston 110 rises together with the center piston 120, as illustrated in FIG. 26. Here, the upward force acting on the lower piston 110 and the center piston 120 is the product of the pressure in the first air chamber RM1 and the pressure-receiving area of the lower piston 110 on which the pressure acts. On the other hand, the downward force acting on the lower piston 110 and the center piston 120 is the biasing force of the center spring SP2. When the center piston 120 rises, the boss base 130 rises together with the center piston 120.

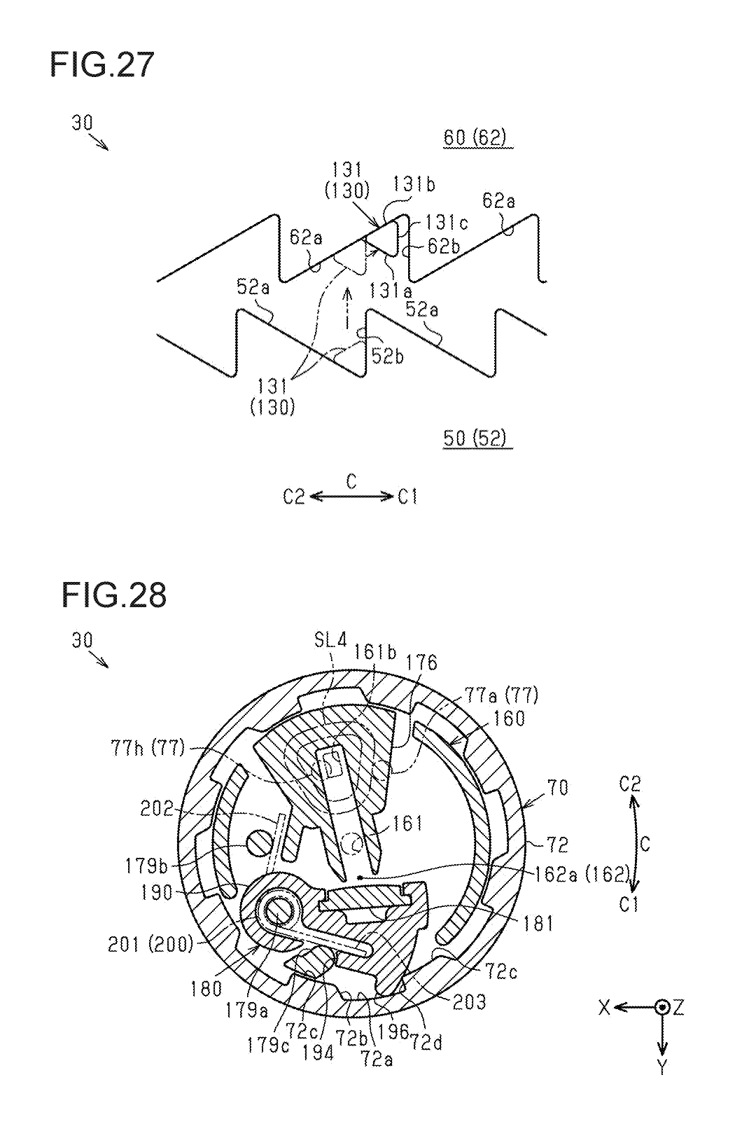

When the boss base 130 rises, the boss 131 of the boss base 130 shifts from the state of being engaged with the lower guide 50 to the state of being engaged with the upper guide 60, as illustrated in FIG. 27. Specifically, it is shifted from a state where the lower cam surface 131a of the boss base 130 is in contact with the lower sliding surface 52a of the lower guide 50 to a state where the upper cam surface 131b of the boss base 130 is in contact with the upper sliding surface 62a of the upper guide 60, as indicated by the two-dot chain line arrows in FIG. 27. When the center piston 120 continues to rise even after the upper cam surface 131b of the boss base 130 comes into contact with the upper sliding surface 62a of the upper guide 60, the upper cam surface 131b of the boss base 130 slides against the upper sliding surface 62a of the upper guide 60, as indicated by the solid-line arrow in FIG. 27. That is, the boss base 130 rotates in the first circumferential direction C1 while rising.

When the boss base 130 rotates, the rotary 160 rotates together with the boss base 130. When the boss 131 of the boss base 130 moves to the position indicated by the solid line in FIG. 27, the rotary 160 rotates to the position illustrated in FIG. 28. In this way, the rotary 160 rotates in the first circumferential direction C1 when the pressure in the first air chamber RM1 and the pressure in the second air chamber RM2 increase.

When the upper cam surface 131b of the boss base 130 slides against the upper sliding surface 62a of the upper guide 60 as illustrated in FIG. 27, the engagement relationship between the sliding portion 196 of the on-off valve 180 and the valve case 70 changes as illustrated in FIG. 28. Specifically, it is shifted from a state where the sliding portion 196 of the on-off valve 180 faces the third sliding surface 72c of the valve case 70 to a state where the sliding portion faces the first sliding surface 72a positioned by being shifted from the third sliding surface 72c in the first circumferential direction C1. At this time, the on-off valve 180 slides against the third sliding surface 72c as the rotary 160 rotates in the first circumferential direction C1.

The third sliding surface 72c is a curved surface along the circumferential direction C and is a curved surface close to the rotational axis of the rotary 160. Therefore, when the sliding portion 196 of the on-off valve 180 slides against the third sliding surface 72c, the state where the on-off valve 180 is located at the closed position is maintained. When the sliding portion 196 of the on-off valve 180 stops sliding against the third sliding surface 72c as the rotary 160 rotates in the first circumferential direction C1, the on-off valve 180 rotates in the opening direction by the restoring force of the torsion spring 200. That is, the on-off valve 180 is displaced from the closed position to the open position. In this way, when the center piston 120 rises, the rotary 160 is switched from the air-supply state to the exhaust state where the exhaust flow path 162 is connected to the outside air. The rotary 160 is switched from the air-supply state to the exhaust state before the boss 131 of the boss base 130 comes into contact with the upper restricting surface 62b of the upper guide 60.

Even when the on-off valve 180 is located at the open position, the air-supply flow path 161 of the rotary 160 is connected to the connecting flow path 77h of the valve case 70, as illustrated in FIG. 26. That is, the connecting flow path 77h is located inside the fourth seal SL4 of the rotary 160 in FIG. 28. Therefore, the air-supply flow path 161 of the rotary 160 is connected to the air bag 21h. Therefore, air is discharged from the second air chamber RM2 to the outside air, and air is discharged from the air bag 21h to the outside air. The air discharged from the exhaust flow path 162 of the rotary 160 is discharged to the outside air through the gap between the upper guide 60 and the valve case 70. As described above, the pressure in the second air chamber RM2 decreases, and the air bag 21h contracts. When the pressure in the second air chamber RM2 decreases, the pressure in the first air chamber RM1 also decreases.

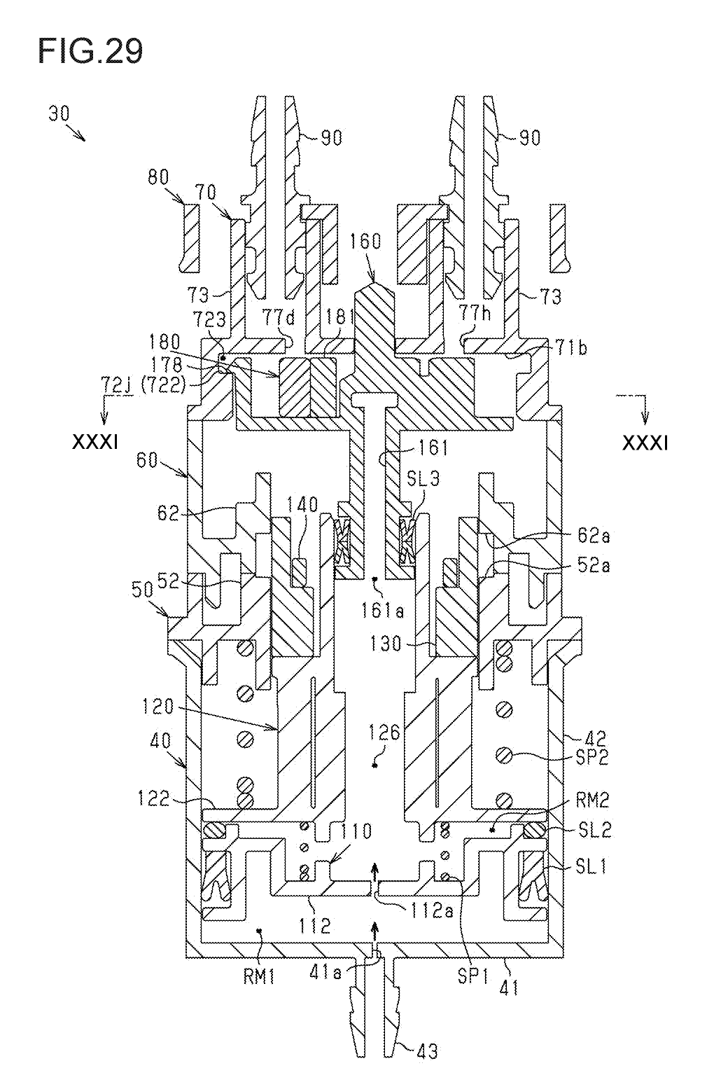

As the pressure in the first air chamber RM1 decreases and when the downward force acting on the lower piston 110 and the center piston 120 becomes larger than the upward force acting on the lower piston 110 and the center piston 120, the lower piston 110 descends together with the center piston 120, as illustrated in FIG. 29. Here, the upward force acting on the lower piston 110 and the center piston 120 is the product of the pressure in the first air chamber RM1 and the pressure-receiving area of the lower piston 110 on which the pressure acts. On the other hand, the downward force acting on the lower piston 110 and the center piston 120 is the biasing force of the center spring SP2. When the center piston 120 descends, the boss base 130 descends together with the center piston 120.

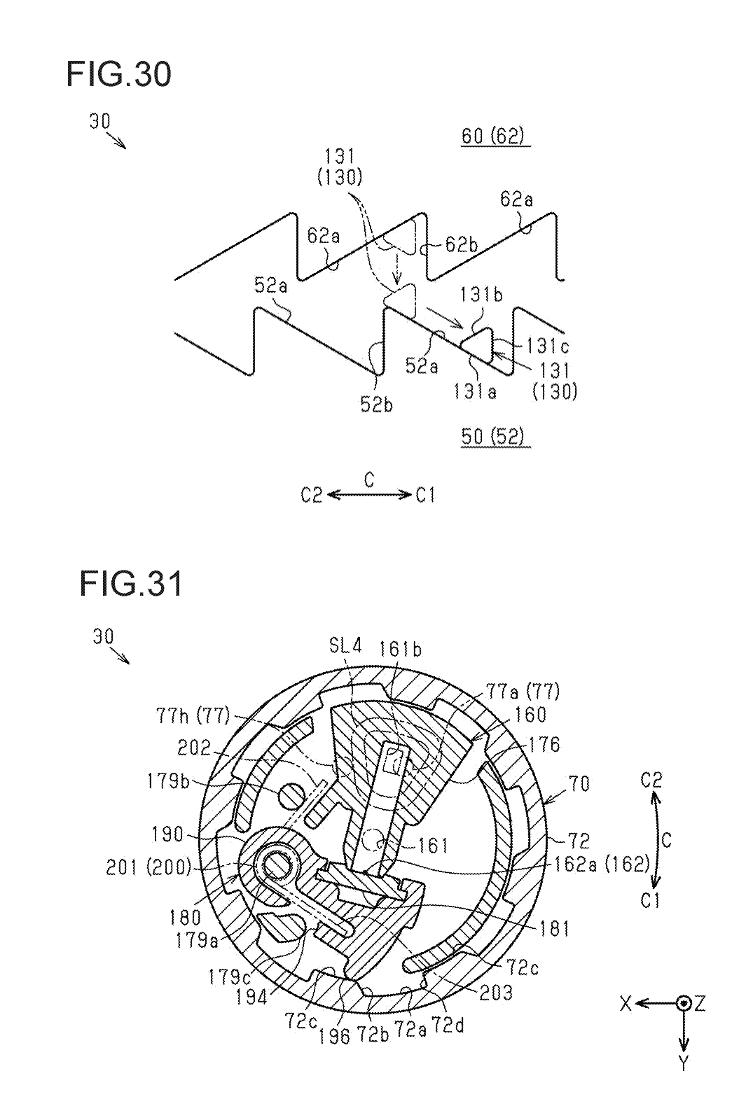

When the boss base 130 descends, the boss 131 of the boss base 130 shifts from the state of being engaged with the upper guide 60 to the state of being engaged with the lower guide 50, as illustrated in FIG. 30. Specifically, it is shifted from a state where the upper cam surface 131b of the boss base 130 is in contact with the upper sliding surface 62a of the upper guide 60 to a state where the lower cam surface 131a of the boss base 130 is in contact with the lower sliding surface 52a of the lower guide 50, as indicated by the two-dot chain line arrow in FIG. 30. When the center piston 120 continues to descend even after the lower cam surface 131a of the boss base 130 comes into contact with the lower sliding surface 52a of the lower guide 50, the lower cam surface 131a of the boss base 130 slides against the lower sliding surface 52a of the lower guide 50, as indicated by the solid-line arrow in FIG. 30. That is, the boss base 130 rotates in the first circumferential direction C1 while descending.

When the boss base 130 rotates, the rotary 160 rotates together with the boss base 130. When the boss 131 of the boss base 130 moves to the position indicated by the solid line in FIG. 30, the rotary 160 rotates to the position illustrated in FIG. 31. In this way, the rotary 160 rotates in the first circumferential direction C1 when the pressure in the first air chamber RM1 and the pressure in the second air chamber RM2 decrease.

When the lower cam surface 131a of the boss base 130 slides against the lower sliding surface 52a of the lower guide 50 as illustrated in FIG. 30, the engagement relationship between the sliding portion 196 of the on-off valve 180 and the valve case 70 changes as illustrated in FIG. 31. Specifically, it is shifted from a state where the sliding portion 196 of the on-off valve 180 faces the first sliding surface 72a of the valve case 70 to a state where the sliding portion faces the third sliding surface 72c positioned by being shifted from the first sliding surface 72a in the first circumferential direction C1. At this time, the sliding portion 196 of the on-off valve 180 slides against the first sliding surface 72a, the second sliding surface 72b, and the third sliding surface 72c as the rotary 160 rotates in the first circumferential direction C1.

The first sliding surface 72a is a curved surface along the first circumferential direction C1 and is a curved surface far from the rotational axis of the rotary 160. Therefore, when the sliding portion 196 of the on-off valve 180 slides against the first sliding surface 72a, the state where the on-off valve 180 is located at the open position is maintained. Subsequently, the second sliding surface 72b is an inclined surface that is inclined to approach the rotational axis of the rotary 160 as it advances in the first circumferential direction C1. Therefore, when the sliding portion 196 of the on-off valve 180 slides against the second sliding surface 72b, the on-off valve 180 rotates in the closing direction. While the sliding portion 196 of the on-off valve 180 slides against the second sliding surface 72b, the displacement of the on-off valve 180 to the closed position is completed. Subsequently, the third sliding surface 72c is a curved surface along the first circumferential direction C1 and is a curved surface close to the rotational axis of the rotary 160. Therefore, when the sliding portion 196 of the on-off valve 180 slides against the third sliding surface 72c, the state where the on-off valve 180 is located at the closed position is maintained. In this way, when the center piston 120 descends, the rotary 160 is switched from the exhaust state to the air-supply state. The rotary 160 is switched from the exhaust state to the air-supply state before the boss 131 of the boss base 130 comes into contact with the lower restricting surface 52b of the lower guide 50.

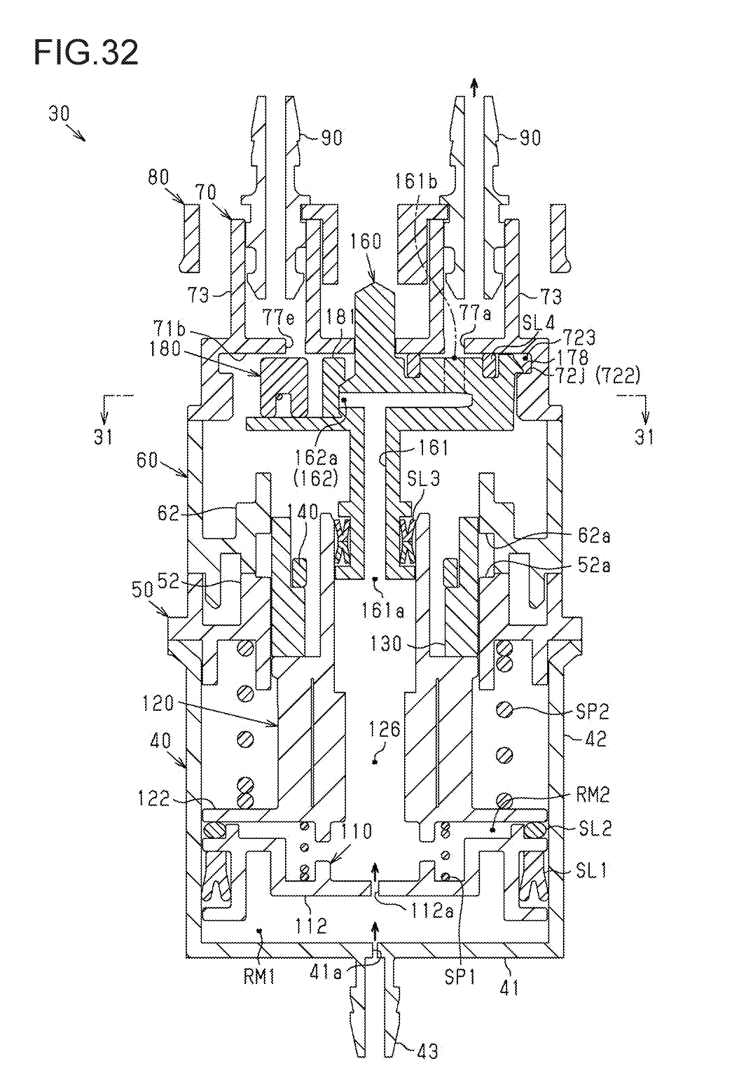

When the boss 131 moves to the position indicated by the solid line in FIG. 30 as the center piston 120 descends, the air-supply flow path 161 of the rotary 160 is not connected to the connecting flow path 77h of the valve case 70, as illustrated in FIGS. 29 and 31. That is, the connecting flow path 77h is not located inside the fourth seal SL4 of the rotary 160 in FIG. 31. As a result, the air-supply flow path 161 of the rotary 160 is not connected to the air bag 21h through the connecting flow path 77h. On the other hand, the air-supply flow path 161 of the rotary 160 is connected to the connecting flow path 77a of the valve case 70, as illustrated in FIGS. 31 and 32. That is, the connecting flow path 77a is located inside the fourth seal SL4 of the rotary 160 in FIG. 31. As a result, the air-supply flow path 161 of the rotary 160 is connected to the next air bag 21a through the connecting flow path 77a.

The states illustrated in FIGS. 29 and 32 are substantially the same state except that the rotary 160 rotates by slightly less than 45° in the first circumferential direction C1 from the state illustrated in FIG. 25. Therefore, when the pump 24 is continuously driven in the state illustrated in FIG. 29, the air bag 21a expands and then contracts. Thereafter, when the pump 24 is continuously driven, the air bag 21b expands and then contracts. As described above, the rotary valve 30 sequentially switches the air bags 21 that expand and contract.

As described above, in the rotary valve 30, the rotary 160 sequentially switches the air-supply state and the exhaust state for the eight air bags 21 during one rotation. That is, the rotary 160 sequentially switches 16 states during one rotation.

### Operation When Drive of Pump 24 Is Stopped

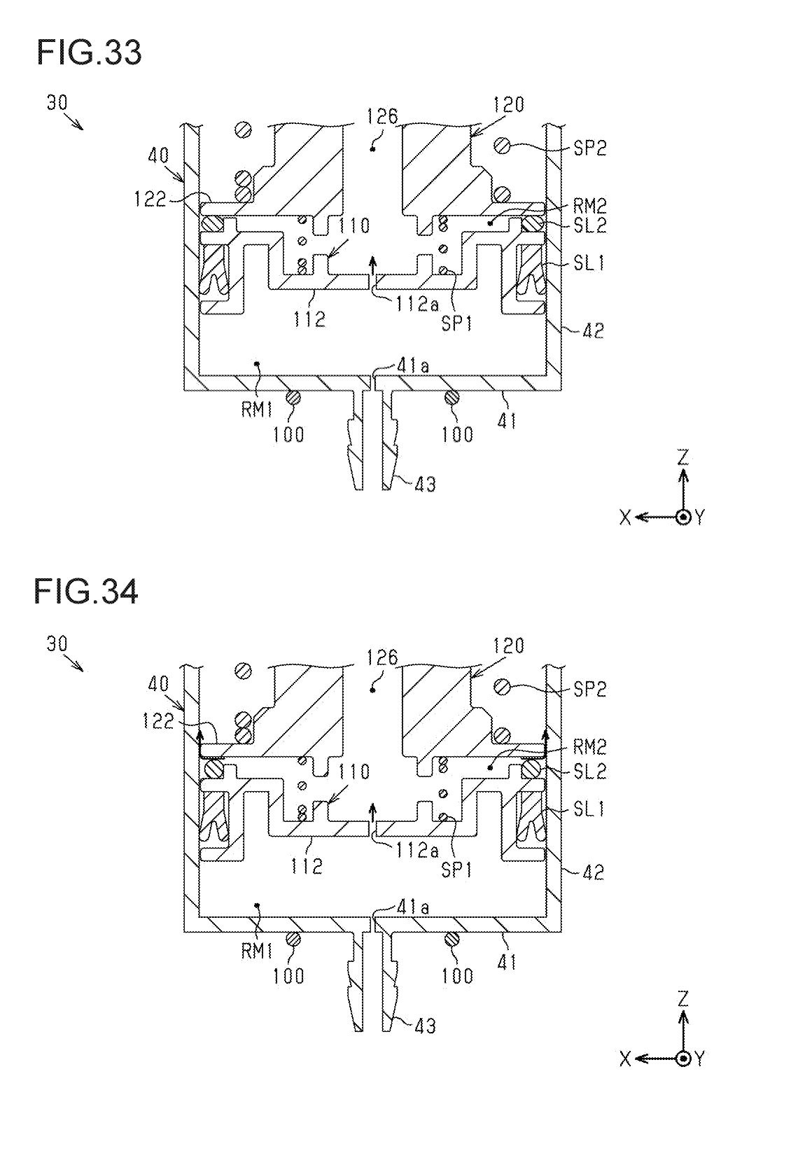

The operation of the rotary valve 30 when the drive of the pump 24 is stopped will be described with reference to FIGS. 33 and 34.

As described above, under a situation where air is supplied from the pump 24 to the rotary valve 30, the on-off valve 180 is repeatedly displaced between the closed position and the open position. Therefore, depending on the timing at which the drive of the pump 24 is stopped, the on-off valve 180 may be located at the closed position, or the on-off valve 180 may be located at the open position. Note that the timing at which the drive of the pump 24 is stopped includes a timing at which a user turns off the power supply system of the vehicle, a timing at which a user ends the massage by the pneumatic system 20, and the like. In this respect, the timing at which the drive of the pump 24 is stopped is unrelated to the position of the on-off valve 180.

For example, when the air supply from the pump 24 is stopped while the on-off valve 180 is located at the closed position, air is not discharged from the air bag 21 connected to the air-supply flow path 161 of the rotary 160. That is, the air bag 21 communicating with the air-supply flow path 161 of the rotary 160 remains expanded. In this case, the seating comfort of the user seated on the seat 10 may be deteriorated. In addition, if the state where the air bag 21 is expanding is continued for a long period of time, there is the risk that age-related deterioration of the air bag 21 may be accelerated. Therefore, in the above case, the rotary valve 30 discharges air from the air bag 21 as follows.

FIG. 33 illustrates a state where the on-off valve 180 of the rotary 160 is located at the closed position, and the drive of the pump 24 is stopped while a certain air bag 21 is expanding. Immediately after the drive of the pump 24 is stopped, the pressure in the first air chamber RM1 and the pressure in the second air chamber RM2 are relatively high, and the pressure in the first air chamber RM1 is higher than the pressure in the second air chamber RM2. In addition, the lower piston 110 is in contact with the center piston 120, and thus the second air chamber RM2 is shielded from the outside air.

Here, when the lower piston 110 is considered as being integrated with the center piston 120, the upward force acting on these pistons is balanced with the downward force acting on these pistons. That is, the product of the pressure in the first air chamber RM1 and the pressure-receiving area of the lower piston 110 on which the pressure acts is equal to the biasing force of the center spring SP2 acting on the center piston 120.

In addition, when the lower piston 110 is considered as a body separate from the center piston 120, the upward force acting on the lower piston 110 is larger than the downward force acting on the lower piston 110. That is, the product of the pressure in the first air chamber RM1 and the pressure-receiving area of the lower piston 110 on which the pressure acts is larger than the sum of the product of the pressure in the second air chamber RM2 and the pressure-receiving area of the lower piston 110 on which the pressure acts and the biasing force of the lower spring SP1.

Furthermore, when the center piston 120 is considered as a body separate from the lower piston 110, the upward force acting on the center piston 120 is smaller than the downward force acting on the center piston 120. That is, the sum of the product of the pressure in the second air chamber RM2 and the pressure-receiving area of the center piston 120 on which the pressure acts and the biasing force of the lower spring SP1 is smaller than the biasing force of the center spring SP2.

When time elapses after the drive of the pump 24 is stopped, air flows from the first air chamber RM1 into the second air chamber RM2, as indicated by the solid-line arrow in FIG. 33. As a result, the pressure difference between the first air chamber RM1 and the second air chamber RM2 decreases. When the pressure difference between the first air chamber RM1 and the second air chamber RM2 decreases, the upward force acting on the lower piston 110 decreases and the downward force acting on the lower piston 110 increases. Then, the upward force acting on the lower piston 110 is smaller than the downward force acting on the lower piston 110. As a result, the lower piston 110 slightly descends with respect to the center piston 120, as illustrated in FIG. 34. That is, as the lower piston 110 is spaced apart from the center piston 120, the second air chamber RM2 is connected to the outside air.

When the second air chamber RM2 is connected to the outside air, air is discharged from the second air chamber RM2 to the outside air as indicated by the solid-line arrows in FIG. 34, and thus the pressure in the second air chamber RM2 decreases. Then, the downward force acting on the lower piston 110 decreases. Therefore, the descending speed of the lower piston 110 may decrease, or the lower piston 110 may stop. In addition, the upward force acting on the center piston 120 decreases. Therefore, the center piston 120 descends until the center piston 120 comes into contact with the lower piston 110. That is, the second air chamber RM2 is shielded from the outside air again.

While the lower piston 110 and the center piston 120 are descending, the state where the pressure in the first air chamber RM1 is higher than the pressure in the second air chamber RM2 is maintained. Therefore, air flows from the first air chamber RM1 into the second air chamber RM2, and thus the pressure difference between the first air chamber RM1 and the second air chamber RM2 decreases. That is, after the lower piston 110 descends, the center piston 120 also descends to follow the lower piston 110, as described above. In this way, the lower piston 110 and the center piston 120 descend while repeatedly coming into contact with and being spaced apart from each other.

When the center piston 120 descends, the boss base 130 descends together with the center piston 120. That is, the engagement relationship between the boss base 130 and the lower guide 50 changes, as in the case illustrated in FIG. 30. Therefore, the boss base 130 descends without rotating in the circumferential direction C until the boss 131 of the boss base 130 comes into contact with any lower sliding surface 52a of the lower guide 50. Subsequently, after the boss 131 of the boss base 130 comes into contact with any lower sliding surface 52a of the lower guide 50, the boss base 130 descends while rotating in the first circumferential direction C1. As a result, the rotary 160 is switched from the air-supply state to the exhaust state. Therefore, air is discharged from the second air chamber RM2 and air is discharged from the air bag 21.

When the boss 131 of the boss base 130 comes into contact with both the lower sliding surface 52a and the lower restricting surface 52b of the lower guide 50 as the center piston 120 continues to descend, the center piston 120 finishes descending to the initial position PC0. Therefore, after the center piston 120 descends to the initial position PC0, the lower piston 110 descends with respect to the center piston 120. In this way, the lower piston 110 descends to the initial position PL0. As described above, even when the drive of the pump 24 is stopped while the rotary 160 is in the air-supply state, the air bag 21 is not left expanded.

### Effects of Present Embodiment

(1) In the rotary valve 30, the rotary 160 includes the claw portion 178 locked to the valve case 70. In this way, the rotary 160 is restricted from moving up and down with respect to the valve case 70, and is allowed to rotate with respect to the valve case 70. In this respect, the rotary valve 30 does not require a new configuration for pressing the rotary 160 against the opening surface 71b of the valve case 70. Therefore, the rotary valve 30 can reduce the number of components constituting the device.

(2) When the rotary 160 is mounted on the valve case 70, the elastic wall 177 of the rotary 160 is temporarily elastically deformed, so that the claw portion 178 of the rotary 160 can be accommodated in the accommodating groove 723 of the valve case 70. In other words, the rotary 160 is mounted on the valve case 70 by so-called snap fit. In this way, the rotary valve 30 can realize a configuration that allows rotation of the rotary 160 while restricting vertical movement of the rotary 160, with a simple configuration.

(3) The rotary 160 has a plurality of claw portions 178. Therefore, the rotary valve 30 can increase the number of engagement points between the claw portions 178 of the rotary 160 and the valve case 70 in the rotational direction of the rotary 160. Therefore, the rotary valve 30 can easily restrict vertical movement of the rotary 160. In a case where the plurality of claw portions 178 are provided on one elastic wall 177, the length of one elastic wall 177 becomes long in the rotational direction of the rotary 160. In this case, when the rotary 160 is accommodated in the valve case 70, one elastic wall 177 may be less likely to be elastically deformed. In this respect, in the rotary valve 30, the rotary 160 has a plurality of elastic walls 177 arranged at intervals in the rotational direction of the rotary 160. Therefore, the rotary valve 30 can suppress occurrence of the above situation.

(4) The sliding wall 72 of the valve case 70 has an accommodating groove 723 in which the plurality of claw portions 178 of the rotary 160 are accommodated, eight first sliding surfaces 72a, eight second sliding surfaces 72b, eight third sliding surfaces 72c, and eight connecting surfaces 72d that slide against the on-off valve 180 of the rotary 160. In other words, the valve case 70 has a function of allowing rotation of the rotary 160 while suppressing vertical movement of the rotary 160, and a function of displacing the on-off valve 180 between the closed position and the open position by sliding against the on-off valve 180. In this way, the rotary valve 30 can further reduce the number of components constituting the device by providing the valve case 70 with the plurality of functions.

(5) The shapes of the upper shaft portion 173, the elastic wall 177, and the claw portion 178 of the rotary 160 and the shape of the sliding wall 72 of the valve case 70 are configured to satisfy the following conditions. That is, such shapes are configured such that, in a case where the rotary 160 is mounted on the valve case 70, the claw portion 178 of the rotary 160 comes into contact with the sliding wall 72 of the valve case 70 after the upper shaft portion 173 of the rotary 160 is inserted into the shaft hole 71a of the valve case 70. Therefore, the rotary valve 30 can suppress the rotary 160 from being inserted into the valve case 70 in a state where the elastic wall 177 and the claw portion 178 of the rotary 160 are inclined with respect to the axis of the valve case 70.

(6) The sliding wall 72 of the valve case 70 has the insertion guide surface 72h. The plurality of claw portions 178 of the rotary 160 have inclined surfaces 178a. Therefore, when the rotary 160 is mounted on the valve case 70, the rotary valve 30 can guide the plurality of claw portions 178 of the rotary 160 toward the axis of the rotary 160. In addition, the rotary valve 30 can elastically deform the plurality of elastic walls 177 of the rotary 160 toward the axis of the rotary 160. That is, the rotary valve 30 can suppress the rotary 160 from being mounted on the valve case 70 in an inclined state. Furthermore, the rotary valve 30 can enhance work efficiency when the rotary 160 is mounted on the valve case 70.

(7) As described above, when the rotary 160 rotates, the claw portion 178 of the rotary 160 sequentially slides against the eight rotation guide surfaces 72i and the eight holding surfaces 72j of the valve case 70. Therefore, when the rotary 160 rotates, a certain claw portion 178 of the rotary 160 starts to slide against a rotation guide surface 72i existing at a position advanced in the first circumferential direction C1 from a certain holding surface 72j after finishing sliding against the certain holding surface 72j. Here, the rotation guide surface 72i of the valve case 70 is inclined toward the opening surface 71b of the valve case 70 as it advances in the first circumferential direction C1, as illustrated in FIG. 10. Therefore, when the rotary 160 rotates, a certain claw portion 178 of the rotary 160 is less likely to interfere with the sliding projection 722 existing in the first circumferential direction C1 from a certain holding surface 72j after finishing sliding against the certain holding surface 72j. That is, when the rotary 160 rotates, a certain claw portion 178 of the rotary 160 smoothly transitions from a state of sliding against a certain holding surface 72j to a state of sliding against a holding surface 72j existing in the first circumferential direction C1 from the certain holding surface 72j. In this way, the rotary valve 30 can smoothly rotate the rotary 160.

(8) The claw portion 178 of the rotary 160 is locked to the valve case 70, whereby the elastically compressed state of the fourth seal SL4 is maintained. Therefore, the crushing margin of the fourth seal SL4 can be more easily managed compared to the case where the rotary 160 is pressed against the opening surface 71b of the valve case 70 by a coil spring or the like. As a result, the rotary valve 30 can suppress an increase in sliding resistance between the rotary 160 and the opening surface 71b of the valve case 70, and can suppress a decrease in sealability between the rotary 160 and the opening surface 71b of the valve case 70.

### Modifications

The present embodiment can be implemented by being modified as follows. The present embodiment and the following modifications can be implemented in combination with each other as long as no technical inconsistency arises.

The sliding projection 722 of the valve case 70 may not have the insertion guide surface 72h. That is, the lower surface of the sliding projection 722 of the valve case 70 may be a plane orthogonal to the vertical direction Z.

The sliding projection 722 of the valve case 70 may not have the rotation guide surface 72i. That is, the upper surface of the sliding projection 722 of the valve case 70 may be constituted only by the holding surface 72j.

The rotary 160 may not include the claw portion 178 as the “locking portion”. In this case, the valve case 70 preferably includes a configuration corresponding to the “locking portion”. For example, the “locking portion” of the valve case 70 may have a configuration in which the locking portion presses the fourth seal SL4 of the rotary 160 against the opening surface 71b of the valve case 70 by being in contact with the bottom wall 171 of the rotary 160. In this case, the “locking portion” of the valve case 70 may be molded integrally with the sliding wall 72 of the valve case 70, or may be formed as a body separate from the sliding wall 72 of the valve case 70.

In the rotary 160, the plurality of elastic walls 177 may be cylindrical elastic walls. The plurality of claw portions 178 may be annular claw portions. In this modification, the sliding wall 72 of the valve case 70 is preferably configured to be easily deformed in that, when the rotary is mounted on the valve case 70, the elastic wall 177 of the rotary is less likely to be deformed.

In the rotary 160, the formation positions of the elastic wall 177 and the claw portion 178 can be appropriately changed. In addition, the formation position of the accommodating groove 723 of the valve case 70 can be appropriately changed according to the formation position of the claw portion 178 of the rotary 160. In other words, it is not necessary to provide both the eight first sliding surfaces 72a, the eight second sliding surfaces 72b, the eight third sliding surfaces 72c, and the eight connecting surfaces 72d, and the accommodating groove 723 on the sliding wall 72 of the valve case 70.

The on-off valve 180 may be configured to move in the radial direction between the closed position and the open position.

The pneumatic system 20 can also be mounted on a bed, a mat, and the like in addition to the seat 10.

### Summary of Present Embodiment

(1) A rotary valve that sequentially expands and contracts a plurality of air bags by switching an air-supply mode to the plurality of air bags, the rotary valve including: a lower case that defines an air chamber to which air is supplied from a pump; an upper case that has a plurality of connecting flow paths whose downstream ends are connected to the plurality of air bags, respectively, and an opening surface at which upstream ends of the plurality of connecting flow paths open, and that is stacked above the lower case; and a rotary that is accommodated in the upper case and has an air-supply flow path connected to the air chamber, and that sequentially switches the connecting flow paths connected to the air-supply flow path by rotating about an axis extending in a vertical direction in a state of being in contact with the opening surface of the upper case according to an increase and a decrease in pressure in the air chamber, in which one of the upper case and the rotary has a locking portion that is locked to the other of the upper case and the rotary and that allows rotation of the rotary about the axis extending in the vertical direction while restricting movement of the rotary in the vertical direction.

In the rotary valve, one of the rotary and the upper case has the locking portion. In this way, the rotary is restricted from moving up and down with respect to the upper case, and is allowed to rotate with respect to the upper case. That is, the rotary valve does not require a new configuration for pressing the rotary against the opening surface of the upper case. Therefore, the rotary valve can reduce the number of components constituting the device.

(2) In the rotary valve, it is preferable that the rotary has an elastic wall that extends in the vertical direction and is elastically deformable, and the locking portion, in which: the locking portion is a claw portion extending outward in a radial direction of the rotary from an upper end portion of the elastic wall; and the upper case has an accommodating groove that has an annular shape in which a rotational direction of the rotary is a circumferential direction, and that accommodates the claw portion.

When the rotary is accommodated in the upper case, the elastic wall of the rotary is temporarily elastically deformed, so that the claw portion of the rotary can be accommodated in the accommodating groove of the upper case. In this way, the rotary valve can realize a configuration that allows rotation of the rotary while restricting vertical movement of the rotary, with a simple configuration.

(3) In the rotary valve, it is preferable that the rotary has a plurality of the elastic walls and a plurality of the claw portions, in which the plurality of the elastic walls are arranged at intervals in the rotational direction of the rotary, and the plurality of the claw portions are arranged at intervals in the rotational direction of the rotary.

The rotary valve can increase the number of engagement points between the claw portions of the rotary and the upper case in the rotational direction of the rotary. Therefore, the rotary valve can easily restrict vertical movement of the rotary. In a case where the plurality of claw portions are provided on one elastic wall, the length of the one elastic wall becomes long in the rotational direction of the rotary. In this case, when the rotary is accommodated in the upper case, one elastic wall may be less likely to be elastically deformed. In this respect, in the rotary valve having the above configuration, the rotary has a plurality of elastic walls arranged at intervals in the rotational direction of the rotary. Therefore, the rotary valve can suppress occurrence of the above situation.

(4) In the rotary valve, it is preferable that: the rotary has an exhaust flow path that connects the air-supply flow path and outside air, and an on-off valve that is displaced between a closed position at which an exhaust port that is an opening connected to the outside air in the exhaust flow path is closed and an open position at which the exhaust port is opened while the air-supply flow path is connected to one connecting flow path; the upper case has a sliding wall whose distance to a rotational axis of the rotary changes with respect to the rotational direction of the rotary; the on-off valve is displaced between the closed position and the open position by sliding against the sliding wall of the upper case accompanying the rotation of the rotary; and the accommodating groove is provided in the sliding wall.

In the rotary valve, the sliding wall of the upper case has a function of allowing rotation of the rotary while suppressing vertical movement of the rotary, and a function of displacing the on-off valve between the closed position and the open position by sliding against the on-off valve. In this way, the rotary valve can reduce the number of components constituting the device by providing the upper case with the plurality of functions.

(5) In the rotary valve, it is preferable that: the rotary has a seal surrounding the opening of the air-supply flow path facing the opening surface of the upper case; and the seal is elastically compressed between the seal and the opening surface of the upper case in a state where the locking portion of one of the upper case and the rotary is locked to the other of the upper case and the rotary.

The rotary valve can suppress leakage of air between the air-supply flow path of the rotary and any one of the connecting flow paths of the upper case by the seal. In addition, the seal is elastically compressed by the locking portion of one of the upper case and the rotary being locked to the other of the upper case and the rotary. Therefore, the crushing margin of the seal is less likely to fluctuate compared to the case where the rotary is pressed against the opening surface of the upper case by a coil spring or the like.

(6) In the rotary valve, it is preferable that: the upper case has an upper wall having a disk shape including the opening surface, and a sliding wall extending downward from an outer edge of the upper wall and covering the rotary from an outside in the radial direction; the accommodating groove is provided at a base end of the sliding wall; in the radial direction, a distance from the rotational axis of the rotary to tips of the plurality of claw portions is longer than a distance from the rotational axis of the rotary to an inner peripheral surface of the sliding wall; the sliding wall has an insertion guide surface that is provided at the tip of the sliding wall and is inclined upward as the sliding wall advances inward in the radial direction; and the plurality of the claw portions have inclined surfaces, each of which is inclined upward as the claw portion advances inward in the radial direction.

In the rotary valve, the rotary can be accommodated in the upper case by pushing the rotary upward into the upper case. Here, while the upper case has the insertion guide surface, the plurality of claw portions of the rotary have inclined surfaces. Therefore, when the rotary is pushed upward into the upper case, the inclined surfaces of the plurality of claw portions of the rotary slide against the insertion guide surface of the upper case, and thus the plurality of elastic walls of the rotary are easily elastically deformed toward the axis of the rotary. Therefore, the rotary valve can enhance work efficiency when the rotary is pushed into the upper case.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotary valve that sequentially expands and contracts a plurality of air bags by switching an air-supply mode to the plurality of air bags, the rotary valve comprising:
a lower case that defines an air chamber to which air is supplied from a pump;
an upper case that has a plurality of connecting flow paths whose downstream ends are connected to the plurality of air bags, respectively, and an opening surface at which upstream ends of the plurality of connecting flow paths open, and that is stacked above the lower case; and
a rotary that is accommodated in the upper case and has an air-supply flow path connected to the air chamber, and that sequentially switches the connecting flow paths connected to the air-supply flow path by rotating about an axis extending in a vertical direction in a state of being in contact with the opening surface of the upper case according to an increase and a decrease in pressure in the air chamber, wherein
one of the upper case and the rotary has a locking portion that is locked to the other of the upper case and the rotary and that allows rotation of the rotary about the axis extending in the vertical direction while restricting movement of the rotary in the vertical direction.

2. The rotary valve according to claim 1, wherein
the rotary has an elastic wall that extends in the vertical direction and is elastically deformable, and the locking portion,
the locking portion is a claw portion extending outward in a radial direction of the rotary from an upper end portion of the elastic wall, and
the upper case has an accommodating groove that has an annular shape in which a rotational direction of the rotary is a circumferential direction, and that accommodates the claw portion.

3. The rotary valve according to claim 2, wherein
the rotary has a plurality of the elastic walls and a plurality of the claw portions,
the plurality of the elastic walls are arranged at intervals in the rotational direction of the rotary, and
the plurality of the claw portions are arranged at intervals in the rotational direction of the rotary.

4. The rotary valve according to claim 2, wherein
the rotary has an exhaust flow path that connects the air-supply flow path and outside air, and an on-off valve that is displaced between a closed position at which an exhaust port that is an opening connected to the outside air in the exhaust flow path is closed and an open position at which the exhaust port is opened while the air-supply flow path is connected to one connecting flow path,
the upper case has a sliding wall whose distance to a rotational axis of the rotary changes with respect to the rotational direction of the rotary,
the on-off valve is displaced between the closed position and the open position by sliding against the sliding wall of the upper case accompanying the rotation of the rotary, and
the accommodating groove is provided in the sliding wall.

5. The rotary valve according to claim 3, wherein
the rotary has an exhaust flow path that connects the air-supply flow path and outside air, and an on-off valve that is displaced between a closed position at which an exhaust port that is an opening connected to the outside air in the exhaust flow path is closed and an open position at which the exhaust port is opened while the air-supply flow path is connected to one connecting flow path,
the upper case has a sliding wall whose distance to a rotational axis of the rotary changes with respect to the rotational direction of the rotary,
the on-off valve is displaced between the closed position and the open position by sliding against the sliding wall of the upper case accompanying the rotation of the rotary, and
the accommodating groove is provided in the sliding wall.

6. The rotary valve according to claim 1, wherein
the rotary has a seal surrounding the opening of the air-supply flow path facing the opening surface of the upper case, and
the seal is elastically compressed between the seal and the opening surface of the upper case in a state where the locking portion of one of the upper case and the rotary is locked to the other of the upper case and the rotary.

7. The rotary valve according to claim 3, wherein
the upper case has an upper wall having a disk shape including the opening surface, and a sliding wall extending downward from an outer edge of the upper wall and covering the rotary from an outside in the radial direction,
the accommodating groove is provided at a base end of the sliding wall,
in the radial direction, a distance from the rotational axis of the rotary to tips of the plurality of the claw portions is longer than a distance from the rotational axis of the rotary to an inner peripheral surface of the sliding wall,
the sliding wall has an insertion guide surface that is provided at the tip of the sliding wall and is inclined upward as the sliding wall advances inward in the radial direction, and
the plurality of the claw portions have inclined surfaces, each of which is inclined upward as the claw portion advances inward in the radial direction.
